(19) United States
(12) Patent Application Publication
(10) Pub. No.: US 2025/0091956 A1
(43) Pub. Date: Mar. 20, 2025

(54) SHAPED ARTIFICIAL POLYMER ARTICLES WITH HYBRID METAL OXIDE PARTICLES

(71) Applicant: BASF SE, Ludwigshafen am Rhein (DE)

(72) Inventors: Lili LIU, Tarrytown, NY (US); Edward MALITS, Tarrytown, NY (US); Heinz HERBST, Kaisten (CH); Michele GERSTER, Basel (CH); Rupa Hiremath DARJI, Tarrytown, NY (US); Michael David BURKE, Tarrytown, NY (US); Keith TASK, Beachwood, OH (US); Carmen A. HENDRICKS-GUY, Tarrytown, NY (US); Toan Van PHO, Tarrytown, NY (US); Liangliang QU, Tarrytown, NY (US)

(21) Appl. No.: 18/729,306

(22) PCT Filed: Jan. 17, 2023
(86) PCT No.: PCT/US2023/010918

§ 371 Date: Jul. 16, 2024

Related U.S. Application Data
(60) Provisional application No. 63/300,396, filed on Jan. 18, 2022.

(51) Int. Cl. C04B 35/46; C04B 35/14; C04B 35/626; C04B 35/628; C08J 3/20; C08K 3/22; C08K 3/36; C08K 7/18; C08K 9/02

(52) U.S. Cl. CPC C04B 35/46; C04B 35/14; C04B 35/62655; C04B 35/62821; C08J 3/20; C08K 3/22; C08K 3/36; C08K 7/18; C08K 9/02; C04B 2235/3232; C04B 2235/3418; C04B 2235/528; C04B 2235/5436; C04B 2235/5445; C08K 2003/2241

(57) ABSTRACT

Disclosed in certain embodiments are polymer compositions comprising a hybrid metal oxide particles and methods of preparing the same. In at least one embodiment, hybrid metal oxide particles comprise a continuous matrix of a first metal oxide having embedded therein an array of metal oxide particles comprising a second metal oxide. In at least one embodiment, the hybrid metal oxide particles are substantially non-porous.

### CROSS-REFERENCE TO RELATED APPLICATION(S)

This application claims the benefit of priority of U.S. Provisional Patent Application Ser. No. 63/300,396, filed Jan. 18, 2022, the disclosure of which is hereby incorporated by reference herein in its entirety.

### BACKGROUND

Light stabilizers are used to protect plastics and other materials against degradation from long term exposure to light and UV radiation. This protects against exposure of plastics to the UV radiation in sunlight which initiates degradation through a photo-oxidative process. This process can produce a number of undesirable effects including changes in appearance (discoloration, changes in gloss, and/or chalking), deterioration of mechanical properties, and the formation of visible defects such as cracks. Fluorescent lamps used for indoor lighting also emit UV radiation, but at a much lower intensity than sunlight.

There exists a need in the art for new light stabilizers and UV boosters for the use in polymer compositions.

### SUMMARY OF THE INVENTION

In certain embodiments, the present invention relates to the use of hybrid metal oxide particles as light stabilizers for a shaped artificial polymer or plastic article, and corresponding shaped artificial polymer or plastic articles and corresponding extruded, casted, spun, molded or calendered polymer or plastic compositions.

The hybrid particles are utilized for stabilizing polymers against degradation, especially degradation induced by UV light. In addition, they can be utilized for stabilization in combination with other light stabilizers (e.g., for an additive or synergistic effect).

In certain embodiments, the hybrid articles can be used as light stabilizers in the polymer article in an amount of at 0.1 wt % to about 40 wt % or at 0.1 wt % to about 20 wt % or at 0.1 wt % to about 10 wt % or at 0.1 wt % to about 5 wt %.

In other embodiments, the hybrid articles can be used as a UV booster in the polymer article in an amount of at 0.1 wt % to about 40 wt % or at 0.1 wt % to about 20 wt % or at 0.1 wt % to about 10 wt % or at 0.1 wt % to about 5 wt % in combination with a light absorber in an amount of at 0.1 wt % to about 40 wt % or at 0.1 wt % to about 20 wt % or at 0.1 wt % to about 10 wt % or at 0.1 wt % to about 5 wt %.

The polymer system can be selected from, e.g., polypropylene, polyethylene, polycarbonate (PC), polymethylmethacrylate (PMMA), PET, polystyrene or a combination thereof.

The processing technique for the polymer article on the present invention can utilize, e.g., a Brabender, High-Speed Mixer, single screw extruder, twin-screw extrude, cast film using a drawdown film applicator or a combination thereof.

In one aspect of the present disclosure, a method of preparing a composition comprising a polymer and hybrid metal oxide particles is disclosed, wherein the hybrid particles are prepared by a process that comprises: generating liquid droplets from a particle dispersion comprising first metal oxide particles and second metal oxide particles; drying the liquid droplets to provide dried particles comprising a discrete matrix of the first metal oxide particles embedded with the second metal oxide particles; and heating the dried particles to obtain the hybrid metal oxide particles comprising a continuous matrix formed from the first metal oxide particles embedded with an array of the second metal oxide particles.

In at least one embodiment, the hybrid metal oxide particles are substantially non-porous.

In at least one embodiment, heating the particles comprises sintering or calcining the dried particles to form the continuous matrix by densifying the first metal oxide particles.

In at least one embodiment, the liquid droplets further comprise a binder. In at least one embodiment, heating the dried particles facilitates forming the continuous matrix from the binder and the first metal oxide particles.

In at least one embodiment, the binder comprises a material selected from silica, sodium silicate, magnesium silicate, calcium silicate, aluminum silicate, aluminum oxide hydroxide, sodium oxide, calcium carbonate, calcium aluminate, bentonite, kaolinite, montmorillonite, and combinations thereof.

In at least one embodiment, the first metal oxide particles and the second metal oxide particles independently comprise a metal oxide selected from silica, titania, alumina, zirconia, ceria, iron oxides, zinc oxide, indium oxide, tin oxide, chromium oxide, and combinations thereof.

In at least one embodiment, the first metal oxide particles comprise titania.

In at least one embodiment, the first metal oxide particles have an average diameter from about 1 nm to about 120 nm.

In at least one embodiment, the second metal oxide particles comprise silica.

In at least one embodiment, the second metal oxide particles have an average diameter from about 50 nm to about 999 nm.

In at least one embodiment, one or more of the first metal oxide particles or the second metal oxide particles comprise a core-shell structure.

In at least one embodiment, the second metal oxide particles are spherical metal oxide particles.

In at least one embodiment, one or more of the first metal oxide particles or the second metal oxide particles comprise a surface functionalization. In at least one embodiment, the hybrid metal oxide particles comprise a surface functionalization. In at least one embodiment, the surface functionalization comprises a silane.

In at least one embodiment, the hybrid metal oxide particles have an average diameter from about 0.5 μm to about 100 μm.

In at least one embodiment, generating liquid droplets is performed using a microfluidic process.

In at least one embodiment, generating and drying the liquid droplets is performed using a spray drying process.

In at least one embodiment, generating the liquid droplets is performed using a vibrating nozzle.

In at least one embodiment, drying the droplets comprises evaporation, microwave irradiation, oven drying, drying under vacuum, drying in the presence of a desiccant, or a combination thereof.

In at least one embodiment, the liquid dispersion is an aqueous dispersion, an oil dispersion, an organic solvent dispersion, or a combination thereof.

In at least one embodiment, a weight to weight ratio of the first metal oxide particles to the second metal oxide particles is from about 1/50 to about 10/1.

In at least one embodiment, a weight to weight ratio of the first metal oxide particles to the second metal oxide particles is about 2/3.

In at least one embodiment, a particle size ratio of the first metal oxide particles to the second metal oxide particles is from 1/20 to 1/5.

In at least one embodiment, the array of the second metal oxide particles is an ordered array.

In at least one embodiment, the array of the second metal oxide particles is a disordered array.

In another aspect of the present disclosure, there is disclosed a method of preparing a composition comprising a polymer and hybrid metal oxide particles comprising: generating liquid droplets from a particle dispersion comprising a sol-gel matrix of a precursor of a first metal oxide and particles comprising a second metal oxide; and drying the liquid droplets and densifying the sol-gel matrix into a continuous matrix to produce the hybrid metal oxide particles, the hybrid metal oxide particles comprising an array of the particles comprising the second metal oxide. In at least one embodiment, the array of the particles is embedded in the continuous matrix.

In at least one embodiment, the precursor comprises one or more of a metal alkoxide or a metal chloride.

In at least one embodiment, the precursor is selected from tetraethyl orthosilicate (TEOS), tetramethyl orthosilicate (TMOS), titanium ethoxide, aluminum oxide hydroxide, zirconium hydroxide, zirconium acetate, zirconium oxychloride, aluminum chloride hexahydrate, aluminum chloride, cerium nitrate, cerium dioxide, zinc acetate, zinc acetate dehydrate, tin chloride dehydrate, and combinations thereof.

In another aspect of the present disclosure, there is disclosed a method of preparing a composition comprising a polymer and hybrid metal oxide particles comprising: generating liquid droplets comprising a first binder and a second binder; drying the liquid droplets to provide dried particles comprising a matrix of the first binder embedded with a template of the second binder; and heating the dried particles to obtain the hybrid metal oxide particles comprising a continuous matrix formed from the first binder embedded with an array of the second binder.

In at least one embodiment, the first binder and the second binder are independently selected from sodium silicate, magnesium silicate, calcium silicate, aluminum silicate, aluminum oxide hydroxide, sodium oxide, calcium carbonate, calcium aluminate, bentonite, kaolinite, montmorillonite, and combinations thereof.

In another aspect of the present disclosure, the hybrid metal oxide particles comprise a continuous matrix of a first metal oxide having embedded therein an array of metal oxide particles, the metal oxide particles comprising a second metal oxide. In at least one embodiment, the hybrid metal oxide particles are substantially non-porous.

In at least one embodiment, the first metal oxide and the second metal oxide independently comprise a metal oxide selected from silica, titania, alumina, zirconia, ceria, iron oxides, zinc oxide, indium oxide, tin oxide, chromium oxide, and combinations thereof.

In at least one embodiment, the first metal oxide comprises titania.

In at least one embodiment, the hybrid metal oxide particles are derived from metal oxide particles comprising the first metal oxide having an average diameter from about 1 nm to about 120 nm.

In at least one embodiment, the second metal oxide comprises silica.

In at least one embodiment, the metal oxide particles have an average diameter from about 50 nm to about 999 nm.

In at least one embodiment, the metal oxide particles comprise a core-shell structure.

In at least one embodiment, the metal oxide particles are spherical metal oxide particles.

In at least one embodiment, the metal oxide particles comprise a surface functionalization. In at least one embodiment, the hybrid metal oxide particles comprise surface functionalization on outer surfaces of the hybrid metal oxide particles. In at least one embodiment, the surface functionalization comprises a silane.

In at least one embodiment, the hybrid metal oxide particles have an average diameter from about 0.5 μm to about 100 μm or from about 1 μm to about 10 μm.

In at least one embodiment, a weight to weight ratio of the first metal oxide to the second metal oxide is from about 1/50 to about 10/1.

In at least one embodiment, a weight to weight ratio of the first metal oxide to the second metal oxide is about 2/3.

In at least one embodiment, the array of the metal oxide particles is an ordered array.

In at least one embodiment, the array of the metal oxide particles is a disordered array.

In at least one embodiment, the hybrid metal oxide particles further comprise a light absorber. In at least one embodiment, the light absorber is present from 0.1 wt % to about 40.0 wt %. In at least one embodiment, the light absorber comprises carbon black. In at least one embodiment, the light absorber comprises one or more ionic species.

Another aspect of the present disclosure is directed to a method of preparing a composition comprising a polymer and hybrid metal oxide particles, the method comprising: generating liquid droplets from a particle dispersion comprising a binder and metal oxide particles; and drying the liquid droplets to form hybrid metal oxide particles comprising a matrix of the binder and an array of the metal oxide particles embedded in the matrix.

In at least one embodiment, the method further comprises heating the hybrid metal oxide particles to densify the matrix and form a continuous matrix of the binder. In at least one embodiment, the binder comprises a material selected from silica, sodium silicate, magnesium silicate, calcium silicate, aluminum silicate, aluminum oxide hydroxide, sodium oxide, calcium carbonate, calcium aluminate, bentonite, kaolinite, montmorillonite, and combinations thereof, and wherein the metal oxide particles comprise a metal oxide selected from silica, titania, alumina, zirconia, ceria, iron oxides, zinc oxide, indium oxide, tin oxide, chromium oxide, and combinations thereof.

Another aspect of the present disclosure is directed to polymer compositions comprising hybrid metal oxide particles prepared by the aforementioned processes and the processes described herein.

Another aspect of the present disclosure is directed to polymer compositions comprising hybrid metal oxide particles comprising: a matrix of a first metal oxide having embedded therein metal oxide particles comprising a second metal oxide. In at least one embodiment, the hybrid metal oxide particles are substantially non-porous, and the hybrid metal oxide particles are sintered.

Also as used herein, the term “of” may mean “comprising.” For example, “a liquid dispersion of” may be interpreted as “a liquid dispersion comprising.”

Also as used herein, the terms “particles,” “microspheres,” “microparticles,” “nanospheres,” “nanoparticles,” “droplets,” etc., may refer to, for example, a plurality thereof, a collection thereof, a population thereof, a sample thereof, or a bulk sample thereof.

Also as used herein, the terms “micro” or “micro-scaled,” for example, when referring to particles, mean from 1 micrometer (μm) to less than 1000 μm. The terms “nano” or “nano-scaled,” for example, when referring to particles, mean from 1 nanometer (nm) to less than 1000 nm.

Also as used herein, the term “monodisperse” in reference to a population of particles means particles having generally uniform shapes and generally uniform diameters. A present monodisperse population of particles, for example, may have 90%, 91%, 92%, 93%, 94%, 95%, 96%, 97%, 98%, or 99% of the particles by number having diameters within ±7%, ±6%, ±5%, ±4%, ±3%, ±2%, or ±1% of the average diameter of the population.

Also as used herein, the term “substantially free of other components” means containing, for example, ≤5%, ≤4%, ≤3%, ≤2%, ≤1%, ≤0.5%, ≤0.4%, ≤0.3%, ≤0.2%, or ≤0.1% by weight of other components.

The articles “a” and “an” used herein refer to one or to more than one (e.g., at least one) of the grammatical object. Any ranges cited herein are inclusive.

Also as used herein, the term “about” is used to describe and account for small fluctuations. For example, “about” may mean the numeric value may be modified by ±5%, ±4%, ±3%, ±2%, ±1%, ±0.5%, ±0.4%, ±0.3%, ±0.2%, ±0.1%, or ±0.05%. All numeric values are modified by the term “about” whether or not explicitly indicated. Numeric values modified by the term “about” include the specific identified value. For example, “about 5.0” includes 5.0.

Unless otherwise indicated, all parts and percentages are by weight. Weight percent (wt %), if not otherwise indicated, is based on an entire composition free of any volatiles, that is, based on dry solids content.

### BRIEF DESCRIPTION OF DRAWINGS

The disclosure described herein is illustrated by way of example and not by way of limitation in the accompanying figures.

FIG. 1 illustrate hybrid metal oxide particles utilized in the present invention formed from template and matrix metal oxide particles according to certain embodiments of the present disclosure.

FIG. 2 illustrates a comparison of the structure of hybrid metal oxide particles prepared according to certain embodiments of the present disclosure to porous metal oxide particles.

FIG. 3 shows a schematic of an exemplary spray drying system used in accordance with various embodiments of the present disclosure.

FIG. 4 is a scanning electron microscope (SEM) image of silica template, titania matrix hybrid metal oxide particles with ordered structure produced according to embodiments of the present disclosure.

FIG. 5 is an SEM image of disordered silica template, titania matrix hybrid metal oxide particles produced according to embodiments of the present disclosure.

FIG. 6 is a plot of attenuation across the UV-vis spectrum showing increased relative attenuation in the UV range for zinc oxide template, silica matrix hybrid metal oxide particles produced according to embodiments of the present disclosure.

FIG. 7 is an SEM image of further alumina template, silica matrix hybrid metal oxide particles with ordered structure produced according to embodiments of the present disclosure.

### DETAILED DESCRIPTION

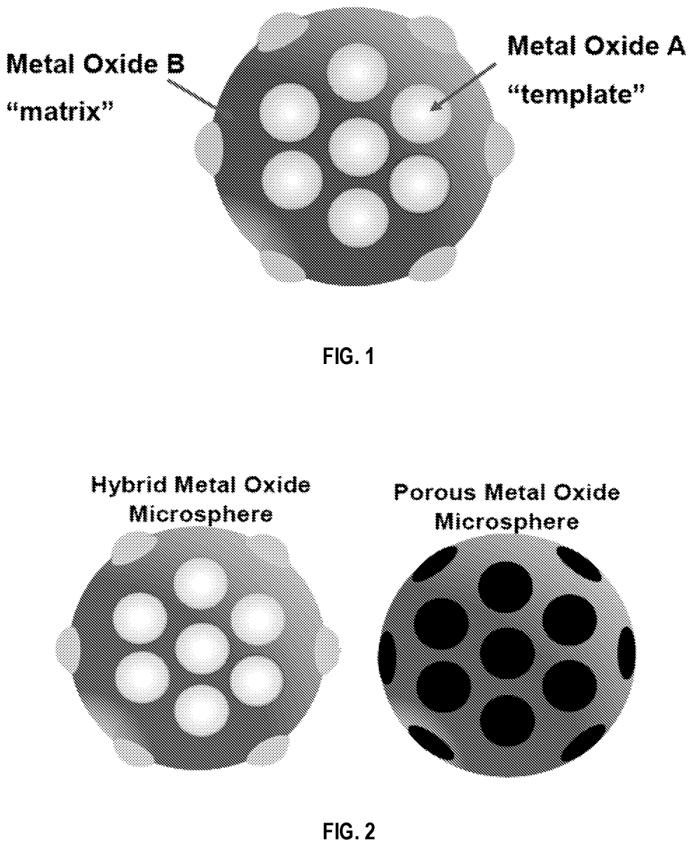

Embodiments of the present disclosure are directed to a composition comprising a plastic material and hybrid metal oxide particles. The hybrid metal oxide particles are in a form of microspheres comprising at least two metal oxides. The microsphere structure comprises a metal oxide matrix in which is embedded a template of spherical nanoparticles comprised of another metal oxide as shown in FIG. 1.

In certain embodiments, the hybrid metal oxide particles are produced by drying droplets of a formulation comprising a matrix of first metal oxide particles (referred to as “matrix” nanoparticles) on the order of 1 to 120 nm in diameter, and second metal oxide nanoparticles (e.g., spherical nanoparticles) on the order of 50 to 999 nm which will form the template (referred to as “template” nanoparticles). In certain embodiments, a spray drying or microfluidics process is used to generate the droplets (e.g., aqueous droplets), and the droplets are dried to remove their solvent. In certain embodiments that utilize a spray drying process, the generation of droplets and drying is performed in rapid succession. During the drying process, the template nanoparticles (metal oxide A of FIG. 1) self-assemble to form a microsphere containing a discrete matrix of metal oxide B particles in which are embedded the template nanoparticles of metal oxide A. The dried particles are then heated under conditions suitable for forming a continuous matrix from the metal oxide B particles in which the metal oxide A particles are embedded. For example, by sintering the matrix nanoparticles (which may contain multiple metal oxides) in a muffle furnace, the matrix nanoparticles densify and form a stable, continuous matrix with the template nanoparticles being retained within the structure. In some embodiments, the droplets further contain a binder (e.g., a material selected from boehmite, alumina sol, silica sol, titania sol, zirconium acetate, ceria sol, or combinations thereof). The dried droplets are then heated under conditions suitable to cause the binder and the metal oxide B particles to form the continuous matrix (e.g., at a temperature of about 300° C. to about 800° C. for a period of about 1 hour to about 8 hours). This final structure is a relatively non-porous solid particle when compared with porous metal oxide microspheres as shown in FIG. 2.

An advantage of this system over a porous metal oxide microsphere is that media infiltration is prevented. The retention of the template in the hybrid metal oxide microsphere ensures that the media cannot infiltrate the structure as it would the voids of the porous metal oxide microsphere. Preventing infiltration maintains a constant net refractive index between the matrix and “void” (nanoparticle template in the case of the hybrid metal oxide microsphere) regardless of the surrounding media in the application.

Hybrid metal oxide particles utilized in the present invention may be prepared according to various methods, including, but not limited to: (1) methods utilizing colloidal metal oxide matrix particles and colloidal metal oxide template particles; (2) methods utilizing colloidal metal oxide matrix particles, colloidal metal oxide template particles, and binder particles; (3) binder particles alone or binder particles in combination with colloidal metal oxide template particles; and (4) colloidal metal oxide template particles in combination with a sol-gel synthesized metal oxide matrix.

Method (1) utilizes metal oxide template particles embedded in discrete metal oxide matrix particles. The structure can be sintered, fusing the matrix particles into a continuous matrix of metal oxide.

Method (2) utilizes metal oxide template and matrix particles in combination with binder particles. The template particles are embedded in a matrix comprising discrete metal oxide matrix particles and binder particles. The structure is heated resulting in a reaction of the binder particles, which results in the formation of a continuous matrix in which are embedded the metal oxide template particles. In an illustrative example, silica particles are used as the template particles, alumina particles are used as the matrix particles, and boehmite is used as the binder particles. The silica template is embedded in a matrix of alumina and boehmite. The structure is heated to a temperature sufficient to dehydrate the boehmite into alumina, forming a continuous matrix of alumina. If different metal oxide template particles were used, such as titania, the result would be a continuous matrix comprising discrete particles of titania embedded in continuous alumina.

Method (3) utilizes binder particles alone or metal oxide template particles in combination with binder particles. A template of binder particles or colloidal metal oxide particles are embedded in a matrix of binder particles. The structure is heated resulting in a reaction of the binder particles, which results in the formation of a continuous matrix of metal oxide template particles or reacted binder particles.

Method (4) utilizes sol-gel synthesis of a metal oxide matrix. The template particles are dispersed in a solution of a metal oxide precursor, such as a metal alkoxide. Hydrolysis of the metal oxide precursor forms an intermediate that serves as a matrix in which the template particles are embedded. The structure is then heated to undergo hydrolysis and condensation of the matrix, resulting in the formation of a continuous matrix of metal oxide. In an illustrative example, alumina template particles are initially dispersed in a solution of tetraethyl orthosilicate (TEOS). Heating converts the TEOS to silica, resulting in the formation of a continuous matrix of silica in which the alumina template particles are embedded.

The resulting hybrid metal oxide particles may be micron-scaled, for example, having average diameters from about 0.5 μm to about 100 μm. In certain embodiments, the hybrid metal oxide particles have an average diameter from about 0.5 μm, about 0.6 μm, about 0.7 μm, about 0.8 μm, about 0.9 μm, about 1.0 μm, about 5.0 μm, about 10 μm, about 20 μm, about 30 μm, about 40 μm, about 50 μm, about 60 μm, about 70 μm, about 80 μm, about 90 μm, about 100 μm, or within any range defined by any of these average diameters (e.g., about 1.0 μm to about 20 μm, about 5.0 μm to about 50 μm, etc.). The metal oxide employed may also be in particle form, and the particles may be nano-scaled. The metal oxide matrix nanoparticles may have an average diameter, for example, of about 1 nm to about 120 nm. The metal oxide template nanoparticles may have an average diameter, for example, of about 50 nm to about 999 nm. One or more of the template nanoparticles or the matrix nanoparticles may be polydisperse or monodisperse. In certain embodiments, either metal oxide may be provided as metal oxide particles or may be formed from a metal oxide precursor, for example, via a sol-gel technique. An exemplary sol-gel process is described as follows: liquid droplets are generated from a particle dispersion (e.g., an aqueous particle dispersion with a pH of 3-5) comprising metal oxide template nanoparticles and a precursor of a metal oxide. The precursor may be, for example, TEOS or tetramethyl orthosilicate (TMOS) as a silica precursor, titanium propoxide as a titania precursor, or zirconium acetate as a zirconium precursor. The liquid droplets are dried to provide dried particles comprising a hydrolyzed precursor of metal oxide that surrounds and coats the metal oxide template nanoparticles.

Certain embodiments of the hybrid metal oxide particles exhibit color in the visible spectrum at a wavelength range selected from the group consisting of 380 nm to 450 nm, 451 nm to 495 nm, 496 nm to 570 nm, 571 nm to 590 nm, 591 nm to 620 nm, 621 nm to 750 nm, 751 nm to 800 nm, and any range defined therebetween (e.g., 496 nm to 620 nm, 450 nm to 750 nm, etc.). In some embodiments, the particles exhibit a wavelength range in the ultraviolet spectrum selected from the group consisting of 100 nm to 400 nm, 100 nm to 200 nm, 200 nm to 300 nm, and 300 nm to 400 nm.

In certain embodiments, the hybrid metal oxide particles are non-porous or substantially non-porous. In certain embodiments, the hybrid metal oxide particles can have, for example, an average diameter of from about 0.5 μm to about 100 μm. In other embodiments, the particles can have, for example, an average diameter of from about 1 μm to about 75 μm.

In certain embodiments, the hybrid metal oxide particles have an average diameter, for example, of from about 1 μm to about 75 μm, from about 2 μm to about 70 μm, from about 3 μm to about 65 μm, from about 4 μm to about 60 μm, from about 5 μm to about 55 μm, or from about 5 μm to about 50 μm; for example, from any of about 5 μm, about 6 μm, about 7 μm, about 8 μm, about 9 μm, about 10 μm, about 11 μm, about 12 μm, about 13 μm, about 14 μm, or about 15 μm to any of about 16 μm, about 17 μm, about 18 μm, about 19 μm, about 20 μm, about 21 μm, about 22 μm, about 23 μm, about 24 μm, or about 25 μm. Other embodiments can have an average diameter of from any of about 4.5 μm, about 4.8 μm, about 5.1 μm, about 5.4 μm, about 5.7 μm, about 6.0 μm, about 6.3 μm, about 6.6 μm, about 6.9 μm, about 7.2 μm, or about 7.5 μm to any of about 7.8 μm about 8.1 μm, about 8.4 μm, about 8.7 μm, about 9.0 μm, about 9.3 μm, about 9.6 μm, or about 9.9 μm.

In certain embodiments, the hybrid metal oxide particles can have, for example, an average diameter of from any of about 4.5 μm, about 4.8 μm, about 5.1 μm, about 5.4 μm, about 5.7 μm, about 6.0 μm, about 6.3 μm, about 6.6 μm, about 6.9 μm, about 7.2 μm, or about 7.5 μm to any of about 7.8 μm about 8.1 μm, about 8.4 μm, about 8.7 μm, about 9.0 μm, about 9.3 μm, about 9.6 μm, or about 9.9 μm.

In certain embodiments, the template nanoparticles and the matrix nanoparticles independently comprise a metal oxide selected from silica, titania, alumina, zirconia, ceria, iron oxides, zinc oxide, indium oxide, tin oxide, chromium oxide, and combinations thereof. In certain embodiments, the template nanoparticles comprise silica. In certain embodiments, the matrix nanoparticles comprise titania.

In certain embodiments, a weight to weight ratio of the first metal oxide particles to the second metal oxide particles is from about 1/10, about 2/10, about 3/10, about 4/10, about 5/10 about 6/10, about 7/10, about 8/10, about 9/10, to about 10/9, about 10/8, about 10/7, about 10/6, about 10/5, about 10/4, about 10/3, about 10/2, or about 10/1. In certain embodiments, the weight to weight ratio is 2/3 or 3/2.

In certain embodiments, a particle size ratio of the metal oxide matrix particles to the metal oxide template particles is from 1/20 to 1/5 (e.g., 1/10).

In certain embodiments, the matrix nanoparticles have an average diameter of from about 1 nm, about 5 nm, about 10 nm, about 15 nm, about 20 nm, about 25 nm, about 30 nm, about 35 nm, about 40 nm, about 45 nm, about 50 nm, about 55 nm, or about 60 nm to about 65 nm, about 70 nm, about 75 nm, about 80 nm, about 85 nm, about 90 nm, about 95 nm, about 100 nm, about 105 nm, about 110 nm, about 115 nm, or about 120 nm. In other embodiments, the matrix nanoparticles have an average diameter of about 5 nm to about 150 nm, about 50 to about 150 nm, or about 100 to about 150 nm.

In certain embodiments, the template nanoparticles have an average diameter of from about 50 nm, about 100 nm, about 150 nm, about 200 nm, about 250 nm, or about 300 nm to about 350 nm, about 400 nm, about 450 nm, about 500 nm, about 550 nm, or about 600 nm.

In further embodiments, the hybrid metal oxide particles can have, for example, from about 60.0 wt % to about 99.9 wt % metal oxide, based on the total weight of the hybrid metal oxide particles. In other embodiments, the structural colorants comprise from about 0.1 wt % to about 40.0 wt % of one or more light absorbers, based on the total weight of the hybrid metal oxide particles. In other embodiments, the metal oxide is from any of about 60.0 wt %, about 64.0 wt %, about 67.0 wt %, about 70.0 wt %, about 73.0 wt %, about 76.0 wt %, about 79.0 wt %, about 82.0 wt %, or about 85.0 wt % to any of about 88.0 wt %, about 91.0 wt %, about 94.0 wt %, about 97.0 wt %, about 98.0 wt %, about 99.0 wt %, or about 99.9 wt % metal oxide, based on the total weight of the hybrid metal oxide particles.

In certain embodiments, the hybrid metal oxide particles are prepared by a method comprising: generating liquid droplets from a particle dispersion comprising first metal oxide particles (e.g., matrix nanoparticles) and second metal oxide particles (e.g., template nanoparticles); drying the liquid droplets to provide dried particles comprising a matrix of the first metal oxide particles embedded with the second metal oxide particles; and sintering the dried particles to densify the matrix and obtain the hybrid metal oxide particles.

In certain embodiments, a liquid dispersion is first formed, for example, by mixing the first metal oxide particles (e.g., matrix nanoparticles) and the second metal oxide particles (e.g., template nanoparticles) in a liquid medium. In certain embodiments, the liquid dispersion is an aqueous dispersion, an oil dispersion, or a combination thereof.

In certain embodiments, the hybrid metal oxide particles may be recovered, for example, by filtration or centrifugation. The recovered particles may then be placed on a substrate, for example, and dried by evaporating the liquid medium. In certain embodiments, the drying comprises microwave irradiation, oven drying, drying under vacuum, drying in the presence of a desiccant, or a combination thereof to evaporate the liquid medium. In certain embodiments, the evaporation of the liquid medium may be performed in the presence of self-assembly substrates such as conical tubes or silicon wafers.

In certain embodiments, droplet formation and collection occur within a microfluidic device. Microfluidic devices are, for example, narrow channel devices having a micron-scaled droplet junction adapted to produce uniform size droplets, with the channels being connected to a collection reservoir. Microfluidic devices, for example, contain a droplet junction having a channel width of from about 10 μm to about 100 μm. The devices are, for example, made of polydimethylsiloxane (PDMS) and may be fabricated, for example, via soft lithography. An emulsion may be prepared within the device via pumping an aqueous dispersed phase and oil continuous phase at specified rates to the device where mixing occurs to provide emulsion droplets. Alternatively, an oil-in-water emulsion may be utilized. The continuous oil phase comprises, for example, an organic solvent, a silicone oil, or a fluorinated oil. As used herein, “oil” refers to an organic phase (e.g., an organic solvent) immiscible with water. Organic solvents include hydrocarbons, for example, heptane, hexane, toluene, xylene, and the like.

In certain embodiments with liquid droplets, the droplets are formed with a microfluidic device. The microfluidic device can contain a droplet junction having a channel width, for example, of from any of about 10 μm, about 15 μm, about 20 μm, about 25 μm, about 30 μm, about 35 μm, about 40 μm, or about 45 μm to any of about 50 μm, about 55 μm, about 60 μm, about 65 μm, about 70 μm, about 75 μm, about 80 μm, about 85 μm, about 90 μm, about 95 μm, or about 100 μm.

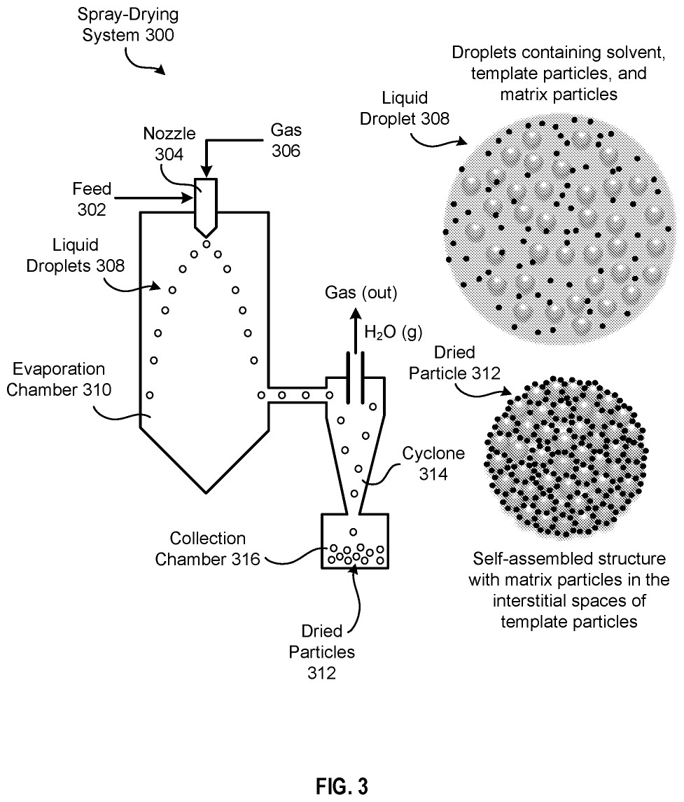

In certain embodiments, generating and drying the liquid droplets is performed using a spray-drying process. FIG. 3 shows a schematic of an exemplary spray drying system 300 used in accordance with various embodiments of the present disclosure. In certain embodiments of spray-drying techniques, a feed 302 of a liquid solution or dispersion is fed (e.g. pumped) to an atomizing nozzle 304 associated with a compressed gas inlet through which a gas 306 is injected. The feed 302 is pumped through the atomizing nozzle 304 to form liquid droplets 308. The liquid droplets 308 are surrounded by a pre-heated gas in an evaporation chamber 310, resulting in evaporation of solvent to produce dried particles 312. The dried particles 312 are carried by the drying gas through a cyclone 314 and deposited in a collection chamber 316. Gases include nitrogen and/or air. In an embodiment of an exemplary spray-drying process, a liquid feed contains a water or oil phase, metal oxide matrix particles, and metal oxide template particles. The dried particles 312 comprise a self-assembled structure of arrayed metal oxide template particles embedded in metal oxide matrix particles.

Air may be considered a continuous phase with a dispersed liquid phase (a liquid-in-gas emulsion). In certain embodiments, spray-drying comprises an inlet temperature of from any of about 100° C., about 105° C., about 110° C., about 115° C., about 120° C., about 130° C., about 140° C., about 150° C., about 160° C., or about 170° C. to any of about 180° C., about 190° C., about 200° C., about 210° C., about 215° C., or about 220° C. In some embodiments a pump rate (feed flow rate) of from any of about 1 mL/min, about 2 mL/min, about 5 mL/min, about 6 mL/min, about 8 mL/min, about 10 mL/min, about 12 mL/min, about 14 mL/min, or about 16 mL/min to any of about 18 mL/min, about 20 mL/min, about 22 mL/min, about 24 mL/min, about 26 mL/min, about 28 mL/min, or about 30 mL/min is utilized.

In some embodiments, vibrating nozzle techniques may be employed. In such techniques, a liquid dispersion is prepared, and then droplets are formed and dropped into a bath of a continuous phase. The droplets are then dried. Vibrating nozzle equipment is available from BUCHI and comprises, for example, a syringe pump and a pulsation unit. Vibrating nozzle equipment may also comprise a pressure regulation valve.

In certain embodiments, the dried hybrid metal oxide particles are subjected to sintering. The sintering can be performed at temperatures of from about 300° C. to about 800° C. for a period of from about 1 hour to about 8 hours. In some embodiments, if the template nanoparticles are monodisperse and ordered within the dried hybrid metal oxide particles prior to sintering, the ordered arrangement of the template nanoparticles may be substantially preserved in the hybrid metal oxide particles after sintering.

In certain embodiments, the hybrid metal oxide particles comprise mainly metal oxide, that is, they may consist essentially of or consist of metal oxide. Advantageously, depending on the particle compositions, relative sizes, and shapes of the metal oxide particles used, a bulk sample of the hybrid metal oxide particles may exhibit color observable by the human eye, may appear white, or may exhibit properties in the UV spectrum. A light absorber may also be present in the particles, which may provide a more saturated observable color. Absorbers include inorganic and organic materials, for example, a broadband absorber such as carbon black. Absorbers may, for example, be added by physically mixing the particles and the absorbers together or by including the absorbers in the droplets to be dried. In certain embodiments, a hybrid metal oxide particle may exhibit no observable color without added light absorber and exhibit observable color with added light absorber.

The hybrid metal oxide particles described herein may exhibit angle-dependent color or angle-independent color. “Angle-dependent” color means that observed color has dependence on the angle of incident light on a sample or on the angle between the observer and the sample. “Angle-independent” color means that observed color has substantially no dependence on the angle of incident light on a sample or on the angle between the observer and the sample.

Angle-dependent color may be achieved, for example, with the use of monodisperse metal oxide particles (e.g., template particles in the present embodiments). Angle-dependent color may also be achieved when a step of drying the liquid droplets is performed slowly, allowing the particles to become ordered. Angle-independent color may be achieved when a step of drying the liquid droplets is performed quickly, not allowing the particles to become ordered.

The following embodiments may be utilized to achieve angle-dependent color resulting from ordered template particles, with the template and matrix particles comprising different metal oxides (e.g., titania matrix particles and silica template particles). As a first example embodiment of angle-dependent color, monodisperse and spherical template particles are embedded in matrix particles, and the matrix particles are subsequently densified. As a second example embodiment of angle-dependent color, two or more species of template particles that are collectively monodisperse and spherical are embedded in matrix particles, and the matrix particles are subsequently densified. Angle-dependent color is achieved independently of the polydispersity and shapes of the matrix particles.

The following embodiments may be utilized to achieve angle-independent color resulting from disordered template particles, with the template and matrix particles comprising different metal oxides (e.g., titania matrix particles and silica template particles). As a first example embodiment of angle-independent color, polydisperse template particles are embedded in matrix (e.g., metal oxide) particles, and the matrix particles are subsequently densified.

As a second example embodiment of angle-independent color, two different sized spherical template particles (i.e., a bimodal distribution of monodisperse template particles) are embedded in matrix particles, and the matrix particles are subsequently densified. The matrix particles may be spherical or non-spherical.

As a third example embodiment of angle-independent color, two different sized and polydisperse spherical template particles are embedded in matrix particles, and the matrix particles are subsequently densified.

Angle-independent color is achieved independently of the polydispersity and shapes of the matrix particles.

Any of the embodiments exhibiting angle-dependent or angle-independent color may be modified to exhibit whiteness or effects (e.g., reflectance, absorbance) in the ultraviolet spectrum.

In some embodiments, the first metal oxide particles and/or the second metal oxide particles can comprise combinations of different types of particles. For example, the first metal oxide particles may be a mixture of two different metal oxides (i.e., discrete distributions of metal oxide particles), such as a mixture of alumina particles and silica particles with each species being characterized by the same or similar size distributions.

In some embodiments, the first metal oxide particles and/or the second metal oxide particles may comprise more complex compositions and/or morphologies. For example, the first metal oxide particles may comprise particles such that each individual particle comprises two or more metal oxides (e.g., silica-titania particles). Such particles may comprise, for example, an amorphous mixture of two or more metal oxides or may have a core-shell configuration (e.g., titania-coated silica particles, polymer-coated silica, carbon black-coated silica, etc.).

In some embodiments, the first metal oxide particles and/or the second metal oxide particles may comprise surface functionalization. An example of a surface functionalization is a silane coupling agent (e.g., silane-functionalized silica). In some embodiments, the surface functionalization is performed on the first metal oxide particles and/or the second metal oxide particles prior to self-assembly and densification. In some embodiments, the surface functionalization is performed on the hybrid metal oxide particles after densification.

Particle size, as used herein, is synonymous with particle diameter and is determined, for example, by scanning electron microscopy (SEM) or transmission electron microscopy (TEM). Average particle size is synonymous with D50, meaning half of the population resides above this point, and the other half resides below this point. Particle size refers to primary particles. Particle size may be measured by laser light scattering techniques with dispersions or dry powders.

The hybrid metal oxide spheres are preferably used in concentrations of from 0.01 wt % to 40.0 wt %, or 0.01 wt % to 20.0 wt %, based on the weight of the shaped artificial polymer article. Other ranges include a concentration of 0.1 wt % to 20.0 wt %, or 0.1 wt % to 10.0 or a concentration of 0.25 wt % to 10.0 wt %, or 0.5 wt % to 10.0 wt %.

The hybrid metal oxide microspheres may be used in combination with one or more light stabilizers, which are selected from, e.g., the group consisting of 2-hydroxyphenyltriazines, benzotriazoles, 2-hydroxybenzophenones, oxalanilides or oxanilides, acrylates, cinnamates, benzoates, benzoxazinones, Ni-Quenchers, HALS (Hindered Amine Light Stabilizer) and NOR-HALS.

The one or more UV absorbers are preferably used in a concentration of from 0.01 wt % to 40.0 wt %, especially 0.01 wt % to 20.0 wt %, based on the weight of the shaped artificial polymer article. More preferred is a concentration of from 0.1 wt % to 20.0 wt %, especially 0.1 wt % to 10.0 wt %.

Benzotriazoles for the combination with the hybrid metal oxide microspheres are preferably those of the formula (Ia)

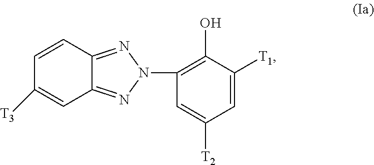

wherein T₁ is hydrogen, C₁-C₁₈alkyl, or C₁-C₁₈alkyl which is substituted by phenyl, or T₁ is a group of the formula

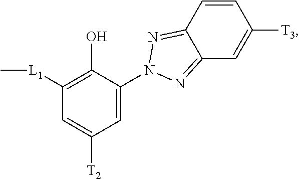

wherein L₁ is a divalent group, for example —(CH₂)ₙ—, where n is from the range 1-8; T₂ is hydrogen, C₁-C₁₈alkyl, or is C₁-C₁₈alkyl which is substituted by COOT₅, C₁-C₁₈alkoxy, hydroxyl, phenyl or C₂-C₁₈acyloxy; T₃ is hydrogen, halogen, C₁-C₁₈alkyl, C₁-C₁₈alkoxy, C₂-C₁₈acyloxy, perfluoroalkyl of 1 to 12 carbon atoms such as —CF₃, or T₃ is phenyl; T₅ is C₁-C₁₈alkyl or C₄-C₅₀alkyl interrupted by one or more O and/or substituted by OH or by a group

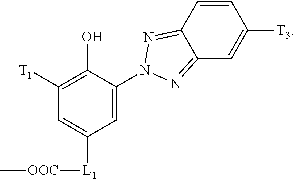

Examples of such benzotriazoles are Tinuvin® PA 328 and Tinuvin® 326 and corresponding UV absorbers given in the list below.

2-Hydroxybenzophenones for the combination with the hybrid metal oxide microspheres are preferably those of the formula (Ib)

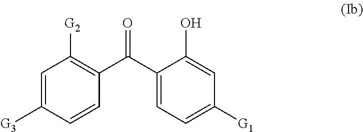

Wherein G₁, G₂ and G₃ independently are hydrogen, hydroxy or C₁-C₁₈alkoxy.

Examples of such 2-hydroxybenzophenones are Chimassorb® 81 and corresponding UV absorbers given in the list below.

Oxalanilides or oxanilides for the combination with the hybrid metal oxide microspheres are preferably those of the formula (Ic)

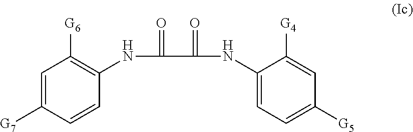

wherein G₄, G₅, G₆ and G₇ independently are hydrogen, C₁-C₁₂alkyl or C₁-C₁₂alkoxy.

Examples thereof are corresponding UV absorbers given in the list below.

Cinnamates for the combination with the hybrid metal oxide microspheres are preferably those of the formula (Id)

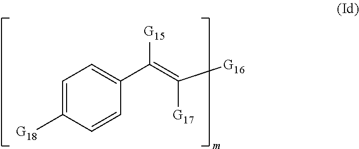

wherein:
m is an integer from 1 to 4;
G₁₅ is hydrogen or phenyl;
if m is 1, G₁₆ is COO-G₁₉;
if m is 2, G₁₆ is C₂-C₁₂alkane-dioxycarbonyl;
if m is 3, G₁₆ is C₃-C₁₂alkane-trioxycarbonyl;
if m is 4, G₁₆ is C₄-C₁₂alkane-tetraoxycarbonyl;
G₁₇ is hydrogen, CN, or is COO-G₁₉;
G₁₈ is hydrogen or methoxy; and
G₁₉ is C₁-C₁₈alkyl.

Examples of such cinnamates are Uvinul® 3035 and corresponding UV absorbers given in the list below.

Benzoates for the combination with the hybrid metal oxide microspheres are preferably those of the formula (Ie)

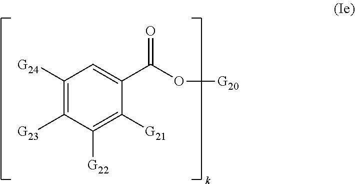

wherein k is 1 or 2; when k is 1, G₂₀ is C₁-C₁₈alkyl, phenyl or phenyl substituted by C₁-C₁₂alkyl, and G₂₁ is hydrogen;

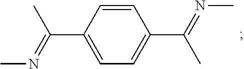

when k is 2, G₂₀ and G₂₁ together are the tetravalent group;
G₂₂ and G₂₄ independently are hydrogen or C₁-C₈alkyl; and
G₂₃ is hydrogen or hydroxy.

Examples of such benzoates are corresponding UV absorbers given in the list below.

2-Hydroxyphenyltriazines for the combination with the hybrid metal oxide microspheres are preferably those of the formula (If)

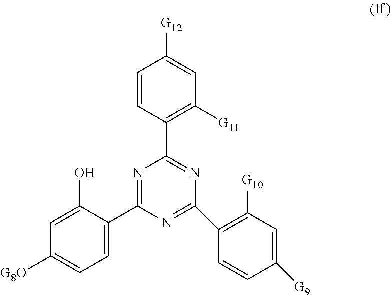

wherein G₈ is C₁-C₁₈alkyl, or is C₄-C₁₈alkyl which is interrupted by COO or OCO or O, or is interrupted by O and substituted by OH;
G₉, G₁₀, G₁₁ and G₁₂ independently are hydrogen, methyl, hydroxy or OG₈;
or of the formula (Ig)

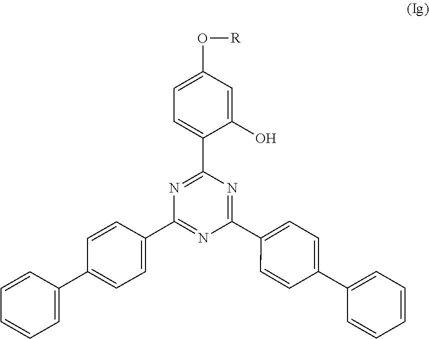

wherein R is C₁-C₁₂alkyl, (CH₂—CH₂—O—)ₙ—R₂; —CH₂—CH(OH)—CH₂—O—R₂; or —CH(R₃)—CO—O—R₄; n is 0 or 1; R₂ is C₁-C₁₃alkyl or C₂-C₂₀alkenyl or C₆-C₁₂aryl or CO—C₁-C₁₈alkyl; R₃ is H or C₁-C₈alkyl; and R₄ is C₁-C₁₂alkyl or C₂-C₁₂alkenyl or C₅-C₆cycloalkyl.

Examples of such 2-hydroxyphenyltriazines are Tinuvin® 1577 and Tinuvin® 1600 and corresponding UV absorbers given in the list below.

In the context of the definitions given, including R₂, R₃ or R₄, alkyl is, for example, branched or unbranched alkyl such as methyl, ethyl, propyl, isopropyl, n-butyl, sec-butyl, isobutyl, t-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 1,1,3-trimethylhexyl, 1,1,3,3-tetramethylpentyl, nonyl, decyl, undecyl, 1-methylundecyl, dodecyl, 1,1,3,3,5,5-hexamethylhexyl, tridecyl, tetradecyl, pentadecyl, hexadecyl, heptadecyl, octadecyl.

Alkyl interrupted by more than one O is, for example, polyoxyalkylene such as a polyethylene glycol residue.

Aryl is in general an aromatic hydrocarbon radical, for example phenyl, biphenylyl or naphthyl.

Within the context of the definitions indicated alkenyl comprises, inter alia, vinyl, allyl, isopropenyl, 2-butenyl, 3-butenyl, isobutenyl, n-penta-2,4-dienyl, 3-methyl-but-2-enyl, n-oct-2-enyl, n-dodec-2-enyl, iso-dodecenyl, n-dodec-2-enyl, n-octadec-4-enyl.

Halogen is mainly fluoro, chloro, bromo or iodo, especially chloro.

C₅-C₆cycloalkyl mainly is cyclopentyl, cyclohexyl.

C₂-C₁₈acyloxy is, for example, alkanoyloxy, benzoyloxy, or alkenoyloxy such as acryloyloxy or methacryloyloxy.

An example for the divalent C₂-C₁₂alkane-dioxycarbonyl is —COO—CH₂CH₂—OCO—; an example for the trivalent C₃-C₁₂alkane-trioxycarbonyl is —COO—CH₂—CH(OCO—)CH₂—OCO—; an example for the tetravalent C₄-C₁₂alkane-tetraoxycarbonyl is (—COO—CH₂)₄C.

Preferably, the one or more UV absorbers for the combination with the hybrid metal oxide microspheres comprise one or more compounds selected from (i) to (lv):
2-(3′,5′-di-tert-butyl-2′-hydroxyphenyl)-5-chlorobenzotriazole,
2-(3′,5′-di-tert-amyl-2′-hydroxyphenyl)benzotriazole,
2-(3′,5′-bis(α,α-dimethylbenzyl)-2′-hydroxyphenyl)benzotriazole,
2-(3′-tert-butyl-2′-hydroxy-5′-(2-octyloxycarbonylethyl)phenyl)benzotriazole,
2,2′-methylene-bis[4-(1,1,3,3-tetramethylbutyl)-6-benzotriazole-2-ylphenol],
the transesterification product of 2-[3′-tert-butyl-5′-(2-methoxycarbonylethyl)-2′-hydroxyphenyl]-2H-benzotriazole with polyethylene glycol 300,
2-[2′-hydroxy-3′-(α,α-dimethylbenzyl)-5′-(1,1,3,3-tetramethylbutyl)phenyl]benzotriazole,
5-trifluoromethyl-2-(2-hydroxy-3-α-cumyl-5-tert-octylphenyl)-2H-benzotriazole,
2-(2′-hydroxy-5′-(2-hydroxyethyl)phenyl)benzotriazole,
2-(2′-hydroxy-5′-(2-methacryloyloxyethyl)phenyl)benzotriazole,
2,4-bis(2,4-dimethylphenyl)-6-(2-hydroxy-4-alkyloxyphenyl)-1,3,5-triazine, where alkyl is a mixture of C₈-alkyl groups (CAS Nos. 137759-38-7; 85099-51-0; 85099-50-9);
2,4-bis(2,4-dimethylphenyl)-6-(2-hydroxy-4-octyloxyphenyl)-1,3,5-triazine (CAS No. 2725-22-6),
2,4-diphenyl-6-(2-hydroxy-4-[α-ethylhexanoyloxyethyl]phenyl)-1,3,5-triazine,
2,4-bis(2-hydroxy-4-butyloxyphenyl)-6-(2,4-bis-butyloxyphenyl)-1,3,5-triazine,
2,4,6-tris(2-hydroxy-4-[1-ethoxycarbonylethoxy]phenyl)-1,3,5-triazine,
the reaction product of tris(2,4-dihydroxyphenyl)-1,3,5-triazine with the mixture of α-chloropropionic esters (made from isomer mixture of C₇-C₉alcohols),
2-[4-(dodecyloxy/tridecyloxy-2-hydroxypropoxy)-2-hydroxyphenyl]-4,6-bis(2,4-dimethylphenyl)1,3,5-triazine,
2-{2-hydroxy-4-[3-(2-ethylhexyl-1-oxy)-2-hydroxypropyloxy]phenyl}-4,6-bis(2,4-dimethylphenyl)-1,3,5-triazine,
2-(2-hydroxy-4-hexyloxyphenyl)-4,6-diphenyl-1,3,5-triazine,
2-(3′-tert.butyl-5′-methyl-2′-hydroxyphenyl)-5-chloro-benzotriazole,
2-(3′-sec. butyl-5′-tert.butyl-2′-hydroxyphenyl)-benzotriazole,
2-(3′,5′-di-tert-butyl-2′-hydroxyphenyl)-benzotriazole,
2-(5′-tert.octyl-2′-hydroxyphenyl)-benzotriazole,
2-(3′-dodecyl-5′-methyl-2′-hydroxyphenyl)-benzotriazole,
2-(3′-tert.butyl-5′-(2-octyloxycarbonylethyl)-2′-hydroxyphenyl)-5-chloro-benzotriazole,
2-(5′-methyl-2′-hydroxyphenyl)-benzotriazole,
2-(5′-tert.butyl-2′-hydroxyphenyl)-benzotriazole,
the compound of formula

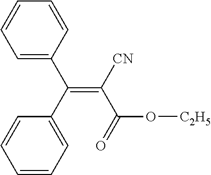 [SMILES: CCOC(=O)C(C#N)=C(c1ccccc1)c1ccccc1]

the compound of formula

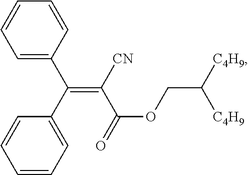

2-ethylhexyl-p-methoxycinnamate (CAS No. 5466-77-3),
2,4-dihydroxybenzophenone,
2-hydroxy-4-methoxybenzophenone,
2-hydroxy-4-dodecyloxybenzophenone,
2-hydroxy-4-octyloxybenzophenone,
2,2′-dihydroxy-4-methoxybenzophenone,
the compound of formula

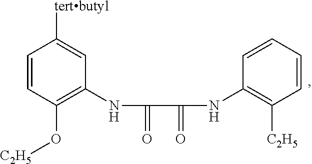

the compound of formula

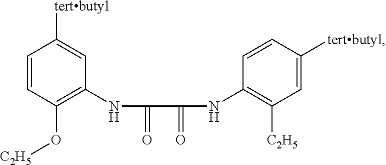

the compound of formula

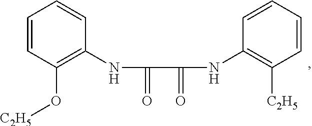 [SMILES: CCOc1ccccc1NC(=O)C(=O)Nc1ccccc1CC]

the compound of formula

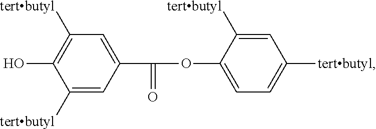

the compound of formula

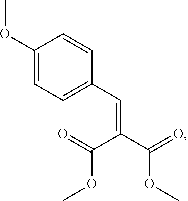 [SMILES: COC(=O)C(=Cc1ccc(OC)cc1)C(=O)OC]

the compound of formula

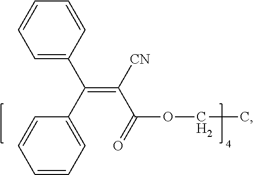

the compound of formula

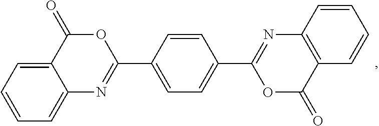 [SMILES: O=c1oc(-c2ccc(-c3nc4ccccc4c(=O)o3)cc2)nc2ccccc12]

the compound of formula

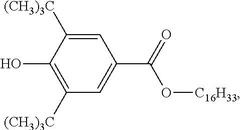

the compound of formula

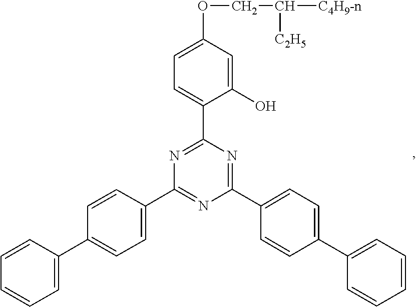

the compound of formula

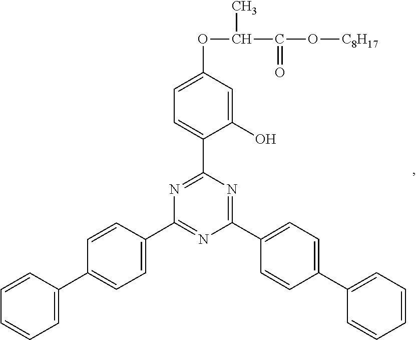

the compound of formula

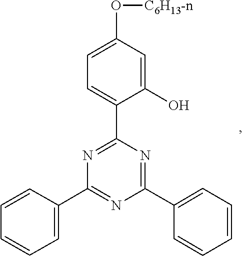

the compound of formula

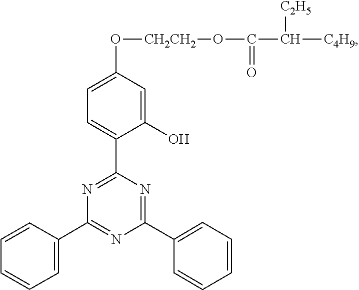

the compound of formula

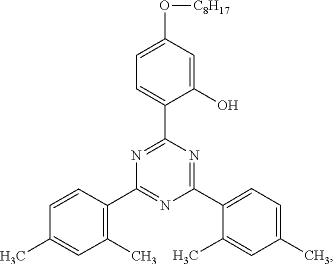

the compound of formula

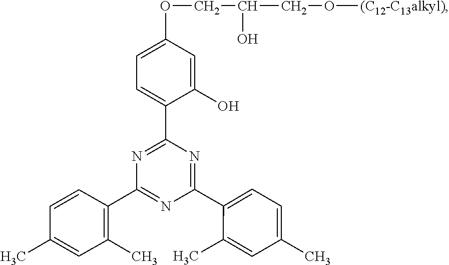

the compound of formula

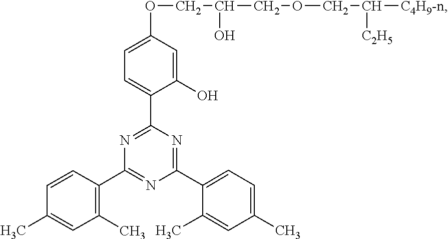

the compound of formula

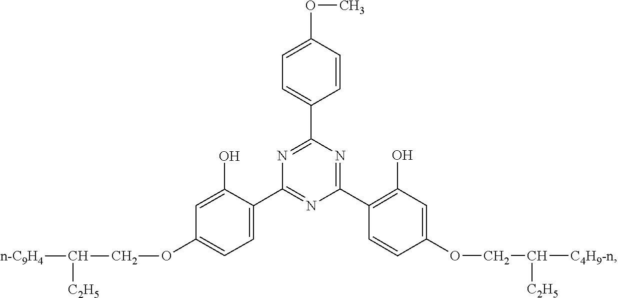

the compound of formula

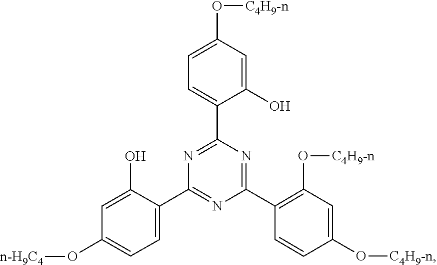

the compound of formula

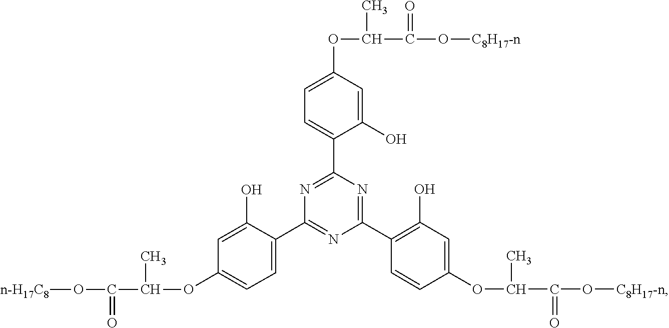

Dodecanedioic acid, 1,12-bis[2-[4-(4,6-diphenyl-1,3,5-triazin-2-yl)-3-hydroxyphenoxy]ethyl]ester (CAS No. 1482217-03-7),
the compound of formula

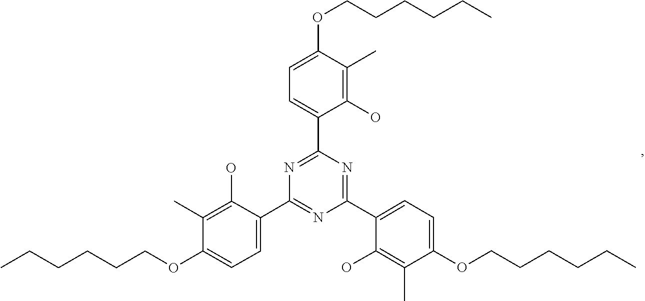 [SMILES: CCCCCCOc1ccc(-c2nc(-c3ccc(OCCCCCC)c(C)c3O)nc(-c3ccc(OCCCCCC)c(C)c3O)n2)c(O)c1C]

or the compound of formula

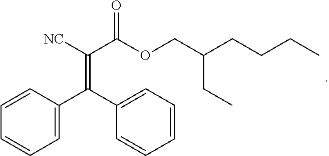 [SMILES: CCCCC(CC)COC(=O)C(C#N)=C(c1ccccc1)c1ccccc1]

In one embodiment, the UV absorbers i-xx and xlvi are preferred.

In a specific embodiment, UV absorbers i-iv, vi-xi, xiii-xviii, xx, xxiii-xxxix, xlvi; especially ii, iii, iv, vi, vii, viii, xx, xxv, xxxvii, xlvi are preferred.

In a further embodiment i-x, xii, xiii, xix-xxiii, xxv-xxvii, xxx-xxxvi, xl-xlv and xlvi; especially i, ii, iii, v, vi, viii, xii, xiii, xix, xx, xxii, xxiii, xxvi, xxx, xxxi, xxxiv, xxxvi, xl, xli, xlii, xliii, xliv, xlv, xlvi are preferred.

Highly preferred as 2-hydroxyphenyltriazines are xii, xlviii and xlvi.

Preferred are 2-hydroxyphenyltriazines, benzotriazoles, 2-hydroxybenzophenones and benzoates, especially 2-hydroxyphenyltriazines, benzotriazoles and 2-hydroxybenzophenones. More preferred are benzotriazoles and 2-hydroxybenzophenones, especially benzotriazoles.

Specific examples of a synthetic polymer or a natural or synthetic elastomer for the shaped artificial polymer articles are:

Polymers of monoolefins and diolefins, for example polypropylene, polyisobutylene, polybut-1-ene, poly-4-methylpent-1-ene, polyvinylcyclohexane, polyisoprene or polybutadiene, polyhexene, polyoctene, as well as polymers of cycloolefins, for instance of cyclopentene, cyclohexene, cyclooctene or nor-bornene, polyethylene (which optionally can be crosslinked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE).

Polyolefins, i.e. the polymers of monoolefins exemplified in the preceding paragraph, preferably polyethylene and polypropylene, can be prepared by different, and especially by the following, methods:
(a) radical polymerisation (normally under high pressure and at elevated temperature);
(b) catalytic polymerisation using a catalyst that normally contains one or more than one metal of groups IVb, Vb, VIb or VIII of the Periodic Table. These metals usually have one or more than one ligand, typically oxides, halides, alcoholates, esters, ethers, amines, alkyls, alkenyls and/or aryls. These metal complexes may be in the free form or fixed on substrates, typically on activated magnesium chloride, titanium(III) chloride, alumina or silicon oxide. These catalysts may be soluble or insoluble in the polymerisation medium. The catalysts can be used by themselves in the polymerisation or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups. These catalyst systems are usually termed Phillips, Standard Oil Indiana, Ziegler (-Natta), TNZ (DuPont), metallocene or single-site catalysts (SSC).

Mixtures of polymers, for example, mixtures of polypropylene with polyisobutylene, polypropylene with polyethylene (for example PP/HDPE, PP/LDPE) and mixtures of different types of polyethylene (for example LDPE/HDPE).

Copolymers of monoolefins and diolefins with each other or with other vinyl monomers, for example, ethylene/propylene copolymers, linear low density polyethylene (LLDPE) and mixtures thereof with low density polyethylene (LDPE), very low density polyethylene, propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene like COC), ethylene/1-olefins copolymers, where the 1-olefin is generated in situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in (a) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.

Hydrocarbon resins (for example C₅-C₉) including hydrogenated modifications thereof (e.g. tackifiers) and mixtures of polyalkylenes and starch.

Homopolymers and copolymers may have any stereostructure including syndiotactic, isotactic, hemi-isotactic or atactic; where atactic polymers are preferred. Stereoblock polymers are also included. Copolymers may by random or block-copolymers, homo- or heterophasic, or High Crystalline Homopolymer.

Polystyrene, poly(p-methylstyrene), poly(α-methylstyrene).

Aromatic homopolymers and copolymers derived from vinyl aromatic monomers including styrene, α-methylstyrene, all isomers of vinyl toluene, especially p-vinyltoluene, all isomers of ethyl styrene, propyl styrene, vinyl biphenyl, vinyl naphthalene, and vinyl anthracene, and mixtures thereof. Homopolymers and copolymers may have any stereostructure including syndiotactic, isotactic, hemi-isotactic or atactic; where atactic polymers are preferred. Stereoblock polymers are also included.

Copolymers including aforementioned vinyl aromatic monomers and comonomers selected from ethylene, propylene, dienes, nitriles, acids, maleic anhydrides, maleimides, vinyl acetate and vinyl chloride or acrylic derivatives and mixtures thereof, for example styrene/butadiene, styrene/acrylonitrile, styrene/ethylene (interpolymers), styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/isoprene/butadiene/styrene, styrene/ethylene/butylene/styrene or styrene/ethylene/propylene/styrene, HIPS, ABS, ASA, AES.

Hydrogenated aromatic polymers derived from hydrogenation of polymers mentioned under 6.), especially including polycyclohexylethylene (PCHE) prepared by hydrogenating atactic polystyrene, often referred to as polyvinylcyclohexane (PVCH).

Hydrogenated aromatic polymers derived from hydrogenation of polymers mentioned under 6a.).

Homopolymers and copolymers may have any stereostructure including syndiotactic, isotactic, hemi-isotactic or atactic; where atactic polymers are preferred. Stereoblock polymers are also included.

Graft copolymers of vinyl aromatic monomers such as styrene or α-methylstyrene, for example styrene on polybutadiene, styrene on polybutadiene-styrene or polybutadiene-acrylonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 6), for example the copolymer mixtures known as ABS, MBS, ASA or AES polymers.

Halogen-containing polymers such as polychloroprene, chlorinated rubbers, chlorinated and brominated copolymer of isobutylene-isoprene (halobutyl rubber), chlorinated or sulfochlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers. Polyvinyl chloride may be rigid or flexible (plasticized).

Polymers derived from α,β-unsaturated acids and derivatives thereof such as polyacrylates and polymethacrylates; polymethyl methacrylates, polyacrylamides and polyacrylonitriles, impact-modified with butyl acrylate.

Copolymers of the monomers mentioned under 9) with each other or with other unsaturated monomers, for example acrylonitrile/butadiene copolymers, acrylonitrile/alkyl acrylate copolymers, acrylonitrile/alkoxyalkyl acrylate or acrylonitrile/vinyl halide copolymers or acrylonitrile/alkyl methacrylate/butadiene terpolymers.

Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned above.

Homopolymers and copolymers of cyclic ethers such as polyalkylene glycols, polyethylene oxide, polypropylene oxide or copolymers thereof with bisglycidyl ethers.

Polyacetals such as polyoxymethylene and those polyoxymethylenes which contain ethylene oxide as a comonomer; polyacetals modified with thermoplastic polyurethanes, acrylates or MBS.

Polyphenylene oxides and sulfides, and mixtures of polyphenylene oxides with styrene polymers or polyamides.

Polyurethanes derived from hydroxyl-terminated polyethers, polyesters or poly-butadienes on the one hand and aliphatic or aromatic polyisocyanates on the other, as well as precursors thereof. Polyurethanes formed by the reaction of: (1) diisocyanates with short-chain diols (chain extenders) and (2) diisocyanates with long-chain diols (thermoplastic polyurethanes, TPU).

Polyamides and copolyamides derived from diamines and dicarboxylic acids and/or from aminocarboxylic acids or the corresponding lactams, for example polyamide 4, polyamide 6, polyamide 6/6, 6/10, 6/9, 6/12, 4/6, 12/12, polyamide 11, polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4,-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or copolyamides modified with EPDM or ABS; and polyamides condensed during processing (RIM polyamide systems). The poylamides may be amorphous.

Polyureas, polyimides, polyamideimides, polyetherimides, polyesterimides, polyhydantoins and polybenzimidazoles.

Polyesters derived from dicarboxylic acids and diols and/or from hydroxycarboxylic acids or the corresponding lactones or lactides, for example polyethylene terephthalate, polybutylene terephthalate, poly-1,4-dimethylolcyclohexane terephthalate, polypropylene terephthalate, polyalkylene naphthalate and polyhydroxybenzoates as well as copolyether esters derived from hydroxyl-terminated polyethers, and also polyesters modified with polycarbonates or MBS. Copolyesters may comprise, for example—but are not limited to—polybutyl-enesuccinate/terephtalate, polybutyleneadipate/terephthalate, polytetramethylenead-ipate/terephthalate, polybutylensuccinate/adipate, polybutylensuccinate/carbonate, poly-3-hydroxybutyrate/octanoate copolymer, poly-3-hydroxybutyrate/hexanoate/decanoate terpolymer. Furthermore, aliphatic polyesters may comprise, for example—but are not limited to—the class of poly(hydroxyalkanoates), in particular, poly(propiolactone), poly(butyrolactone), poly(pivalolactone), poly(valerolactone) and poly(caprolactone), polyethylenesuccinate, polypropylenesuccinate, polybutylenesuccinate, polyhexamethylenesuccinate, polyethyleneadipate, polypropyleneadipate, polybutyleneadipate, polyhexamethyleneadipate, polyethyleneoxalate, polypropyleneoxalate, polybutyleneoxalate, polyhexamethyleneoxalate, polyethylenesebacate, polypropylenesebacate, polybutylenesebacate, polyethylene furanoate and polylactic acid (PLA) as well as corresponding polyesters modified with polycarbonates or MBS. The term “polylactic acid (PLA)” designates a homo-polymer of preferably poly-L-lactide and any of its blends or alloys with other polymers; a co-polymer of lactic acid or lactide with other monomers, such as hydroxy-carboxylic acids, like for example glycolic acid, 3-hydroxy-butyric acid, 4-hydroxy-butyric acid, 4-hydroxy-valeric acid, 5-hydroxy-valeric acid, 6-hydroxy-caproic acid and cyclic forms thereof; the terms “lactic acid” or “lactide” include L-lactic acid, D-lactic acid, mixtures and di-mers thereof, i.e. L-lactide, D-lactide, meso-lacide and any mixtures thereof. Preferred polyesters are PET, PET-G, PBT.

Polycarbonates and polyester carbonates. The polycarbonates are preferably prepared by reaction of bisphenol compounds with carbonic acid compounds, in particular phosgene or, in the melt transesterification process, diphenyl carbonate or dimethyl carbonate. Homopolycarbonates based on bisphenol A and copolycarbonates based on the monomers bisphenol A and 1,1-bis-(4-hydroxyphenyl)-3,3,5-trimethylcyclohexane (bisphenol TMC) are particularly preferred. These and further bisphenol and diol compounds which can be used for the polycarbonate synthesis are disclosed inter alia in WO08037364 (p. 7, line 21 to p. 10, line 5), EP1582549 ([0018] to [0034]), WO02026862 (p. 2, line 23 to p. 5, line 15), WO05113639 (p. 2, line 1 to p. 7, line 20). The polycarbonates can be linear or branched. Mixtures of branched and unbranched polycarbonates can also be used. Suitable branching agents for polycarbonates are known from the literature and are described, for example, in patent specifications U.S. Pat. No. 4,185,009 and DE2500092 (3,3-bis-(4-hydroxyaryl-oxindoles according to the invention, see whole document in each case), DE4240313 (see p. 3, line 33 to 55), DE19943642 (see p. 5, line 25 to 34) and U.S. Pat. No. 5,367,044 as well as in literature cited therein. The polycarbonates used can additionally be intrinsically branched, no branching agent being added here within the context of the polycarbonate preparation. An example of intrinsic branchings are so-called Fries structures, as are disclosed for melt polycarbonates in EP1506249. Chain terminators can additionally be used in the polycarbonate preparation. Phenols such as phenol, alkylphenols such as cresol and 4-tert-butylphenol, chlorophenol, bromophenol, cumylphenol or mixtures thereof are preferably used as chain terminators. Polyester carbonates are obtained by reaction of the bisphenols already mentioned, at least one aromatic dicarboxylic acid and optionally carbonic acid equivalents. Suitable aromatic dicarboxylic acids are, for example, phthalic acid, terephthalic acid, isophthalic acid, 3,3′- or 4,4′-diphenyldicarboxylic acid and benzophenone-dicarboxylic acids. A portion, up to 80 mol-%, preferably from 20 to 50 mol-%, of the carbonate groups in the polycarbonates can be replaced by aromatic dicarboxylic acid ester groups.

### Polyketones.

Polysulfones, polyether sulfones and polyether ketones.

Crosslinked polymers derived from aldehydes on the one hand and phenols, ureas and melamines on the other hand, such as phenol/formaldehyde resins, urea/formaldehyde resins and melamine/formaldehyde resins.

Drying and non-drying alkyd resins.

Unsaturated polyester resins derived from copolyesters of saturated and unsaturated dicarboxylic acids with polyhydric alcohols and vinyl compounds as crosslinking agents, and also halogen-containing modifications thereof of low flammability.

Crosslinkable acrylic resins derived from substituted acrylates, for example epoxy acrylates, urethane acrylates or polyester acrylates.

Alkyd resins, polyester resins and acrylate resins crosslinked with melamine resins, urea resins, isocyanates, isocyanurates, polyisocyanates or epoxy resins.

Crosslinked epoxy resins derived from aliphatic, cycloaliphatic, heterocyclic or aromatic glycidyl compounds, e.g. products of diglycidyl ethers of bisphenol A, bisphenol E and bisphenol F, which are crosslinked with customary hardeners such as anhydrides or amines, with or without accelerators.

Natural polymers such as cellulose, rubber, gelatin and chemically modified homologous derivatives thereof, for example cellulose acetates, cellulose propionates and cellulose butyrates, or the cellulose ethers such as methyl cellulose; as well as rosins and their derivatives.

Blends of the aforementioned polymers (polyblends), for example PP/EPDM, polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and co-polymers, PA/HDPE, PA/PP, PA/PPO, PBT/PC/ABS or PBT/PET/PC.

Naturally occurring and synthetic organic materials which are pure monomeric compounds or mixtures of such compounds, for example mineral oils, animal and vegetable fats, oil and waxes, or oils, fats and waxes based on synthetic esters (e.g. phthalates, adipates, phosphates or trimellitates) and also mixtures of synthetic esters with mineral oils in any weight ratios, typically those used as spinning compositions, as well as aqueous emulsions of such materials.

Aqueous emulsions of natural or synthetic rubber, e.g. natural latex or latices of carboxylated styrene/butadiene copolymers.

Adhesives, for example block copolymers such as SIS, SBS, SEBS, SEPS (S represents styrene, I isoprene, B polybutadiene, EB ethylene/butylene block, EP polyethylene/polypropylene block).

Rubbers, for example polymers of conjugated dienes, e.g. polybutadiene or polyisoprene, copolymers of mono- and diolefins with one another or with other vinyl monomers, copolymers of styrene or α-methylstyrene with dienes or with acrylic derivatives, chlorinated rubbers, natural rubber.

Elastomers, for example Natural polyisoprene (cis-1,4-polyisoprene natural rubber (NR) and trans-1,4-polyisoprene gutta-percha), Synthetic polyisoprene (IR for isoprene rubber), Polybutadiene (BR for butadiene rubber), Chloroprene rubber (CR), polychloroprene, Neoprene, Baypren etc., Butyl rubber (copolymer of isobutylene and isoprene, IIR), Halogenated butyl rubbers (chloro butyl rubber: CIIR; bromo butyl rubber: BIIR), Styrene-butadiene Rubber (copolymer of styrene and butadiene, SBR), Nitrile rubber (copolymer of butadiene and acrylonitrile, NBR), also called Buna N rubbers Hydrogenated Nitrile Rubbers (HNBR) Therban and Zetpol, EPM (ethylene propylene rubber, a copolymer of ethylene and propylene) and EPDM rubber (ethylene propylene diene rubber, a terpolymer of ethylene, propylene and a diene-component), Epichlorohydrin rubber (ECO), Polyacrylic rubber (ACM, ABR), Silicone rubber (SI, Q, VMQ), Fluorosilicone Rubber (FVMQ), Fluoroelastomers (FKM, and FEPM) Viton, Tecnoflon, Fluorel, Aflas and Dai-El, Perfluoroelastomers (FFKM) Tecnoflon PFR, Kalrez, Chemraz, Perlast, Polyether block amides (PEBA), Chlorosulfonated polyethylene (CSM), (Hypalon), Ethylene-vinyl acetate (EVA), Thermoplastic elastomers (TPE), The proteins resilin and elastin, Polysulfide rubber, Elastolefin, elastic fiber used in fabric production.

Thermoplastic elastomers, for example Styrenic block copolymers (TPE-s), Thermoplastic olefins (TPE-o), Elastomeric alloys (TPE-v or TPV), Thermoplastic polyurethanes (TPU), Thermoplastic copolyester, Thermoplastic polyamides, Reactor TPO's (R-TPO's), Polyolefin Plastomers (POP's), Polyolefin Elastomers (POE's).

Most preferred are thermoplastic polymers, like polyolefins and copolymers thereof.

The shaped artificial polymer article of the present invention is for example prepared by one of the following processing steps:

Injection blow molding, extrusion, blow molding, rotomolding, in mold decoration (back injection), slush molding, injection molding, co-injection molding, blow molding, forming, compression molding, resin transfer molding, pressing, film extrusion (cast film; blown film), fiber spinning (woven, non-woven), drawing (uniaxial, biaxial), annealing, deep drawing, calandering, mechanical transformation, sintering, coextrusion, lamination, crosslinking (radiation, peroxide, silane), vapor deposition, weld together, glue, vulcanization, thermoforming, pipe extrusion, profile extrusion, sheet extrusion; sheet casting, strapping, foaming, recycling/rework, visbreaking (peroxide, thermal), fiber melt blown, spun bonded, surface treatment (corona discharge, flame, plasma), sterilization (by gamma rays, electron beams), tape extrusion, pulltrusion, SMC-process or plastisol.

A further embodiment of the present invention are shaped artificial polymer articles wherein the polymer is a synthetic polymer and/or a natural or synthetic elastomer and wherein the polymer contains hybrid metal oxide microspheres as defined herein. As to such articles the definitions and preferences given herein shall apply.

It is preferred that the shaped artificial polymer article is an extruded, casted, spun, molded or calendered shaped artificial polymer article.

Examples of articles according to the present invention are:
Floating devices, marine applications, pontoons, buoys, plastic lumber for decks, piers, boats, kayaks, oars, and beach reinforcements;
Automotive applications, interior applications, exterior applications, in particular trims, bumpers, dashboards, battery, rear and front linings, moldings parts under the hood, hat shelf, trunk linings, interior linings, air bag covers, electronic moldings for fittings (lights), panes for dashboards, headlamp glass, instrument panel, exterior linings, upholstery, automotive lights, head lights, parking lights, rear lights, stop lights, interior and exterior trims; door panels; gas tank; glazing front side; rear windows; seat backing, exterior panels, wire insulation, profile extrusion for sealing, cladding, pillar covers, chassis parts, exhaust systems, fuel filter/filler, fuel pumps, fuel tank, body side mouldings, convertible tops, exterior mirrors, exterior trim, fasteners/fixings, front end module, glass, hinges, lock systems, luggage/roof racks, pressed/stamped parts, seals, side impact protection, sound deadener/insulator and sunroof, door medallion, consoles, instrument panels, seats, frames, skins, automotive applications reinforced, automotive applications fiber reinforced, automotive applications with filled polymers, automotive applications with unfilled polymers;
Road traffic devices, in particular sign postings, posts for road marking, car accessories, warning triangles, medical cases, helmets, tires;
Devices for transportation or public transportation. Devices for plane, railway, motor car (car, motorbike), trucks, light trucks, busses, trams, bikes including furnishings;
Devices for space applications, in particular rockets and satellites, e.g. reentry shields;
Devices for architecture and design, mining applications, acoustic quietized systems, street refuges, and shelters;
Appliances, cases and coverings in general and electric/electronic devices (personal computer, telephone, portable phone, printer, television-sets, audio and video devices), flower
pots, satellite TV bowl, and panel devices;
Jacketing for other materials such as steel or textiles;
Devices for the electronic industry, in particular insulation for plugs, especially computer plugs, cases for electric and electronic parts, printed boards, and materials for electronic data storage such as chips, check cards or credit cards;
Electric appliances, in particular washing machines, tumblers, ovens (microwave oven), dish-washers, mixers, and irons;
Covers for lights (e.g. street-lights, lamp-shades);
Applications in wire and cable (semi-conductor, insulation and cable-jacketing);
Foils for condensers, refrigerators, heating devices, air conditioners, encapsulating of electronics, semi-conductors, coffee machines, and vacuum cleaners;
Technical articles such as cogwheel (gear), slide fittings, spacers, screws, bolts, handles, and knobs;
Rotor blades, ventilators and windmill vanes, solar devices, closets, wardrobes, dividing walls, slat walls, folding walls, roofs, shutters (e.g. roller shutters), fittings, connections between pipes, sleeves, and conveyor belts;
Sanitary articles, in particular mobile toilets, shower cubicles, lavatory seats, covers, and sinks;
Hygienic articles, in particular diapers (babies, adult incontinence), feminine hygiene articles, shower curtains, brushes, mats, tubs, mobile toilets, tooth brushes, and bed pans;
Pipes (cross-linked or not) for water, waste water and chemicals, pipes for wire and cable protection, pipes for gas, oil and sewage, guttering, down pipes, and drainage systems.
Profiles of any geometry (window panes), cladding and siding;
Glass substitutes, in particular extruded plates, glazing for buildings (monolithic, twin or multiwall), aircraft, schools, extruded sheets, window film for architectural glazing, train, transportation and sanitary articles;
Plates (walls, cutting board), silos, wood substitute, plastic lumber, wood composites, walls, surfaces, furniture, decorative foil, floor coverings (interior and exterior applications), flooring, duck boards, and tiles;
Intake and outlet manifolds;
Cement-, concrete-, composite-applications and covers, siding and cladding, hand rails, banisters, kitchen work tops, roofing, roofing sheets, tiles, and tarpaulins;
Plates (walls and cutting board), trays, artificial grass, astroturf, artificial covering for stadium rings (athletics), artificial floor for stadium rings (athletics), and tapes;
Woven fabrics continuous and staple, fibers (carpets/hygienic articles/geotex-tiles/monofilaments; filters; wipes/curtains (shades)/medical applications), bulk fibers (applications such as gown/protection clothes), nets, ropes, cables, strings, cords, threads, safety seat-belts, clothes, underwear, gloves; boots; rubber boots, intimate apparel, garments, swimwear, sportswear, umbrellas (parasol, sunshade), parachutes, paraglides, sails, “balloon-silk”, camping articles, tents, airbeds, sun beds, bulk bags, and bags;
Membranes, insulation, covers and seals for roofs, geomembranes, tunnels, dumps, ponds, walls roofing membranes, geomembranes, swimming pools, swimming pool liners, pool liners, pond liners, curtains (shades)/sun-shields, awnings, canopies, wallpaper, food packing and wrapping (flexible and solid), medical packaging (flexible & solid), airbags/safety belts, arm- and head rests, carpets, centre console, dashboard, cockpits, door, overhead console module, door trim, headliners, interior lighting, interior mirrors, parcel shelf, rear luggage cover, seats, steering column, steering wheel, textiles, and trunk trim;
Films (packaging, rigid packaging, dump, laminating, bale wrap, swimming pools, waste bags, wallpaper, stretch film, raffia, desalination film, batteries, and connectors;
Agricultural films (greenhouse covers, tunnel, multi-tunnel, micro-tunnel, “raspa y amagado”, multi-span, low walk-in tunnel, high tunnel, mulch, silage, silo-bags, silo-stretch, fumigation, air bubble, keder, solawrap, thermal, bale wrap, stretched bale wraps, nursery, film tubes), especially in presence of intensive application of agrochemicals; other agricultural applications (e.g. non-woven soil covers, nets (made of tapes, multi-filaments and conbinations thereof), tarpaulins. Such an agricultural film can either be a mono-layer structure or a multilayer structure, typically made of three, five or seven layers. This can lead to a film structure like A-B-A, A-B-C, A-B-C-B-A, A-B-C-B-D, A-B-C-D-C-B-A, A-A-B-C-B-A-A. A, B, C, D represent the different polymers and tackifiers. However adjacent layers can also be coupled so that the final film article can be made of an even number of layers, i.e. two, four or six layers such as A-A-B-A, A-A-B-B, A-A-B-A-A, A-B-B-A-A, A-A-B-C-B, A-A-B-C-A-A and the like;
Tapes;
Foams (sealing, insulation, barrier), sport and leisure mats;
Sealants;
Food packing and wrapping (flexible and solid), BOPP, BOPET, bottles;
Storage systems such as boxes (crates), luggage, chest, household boxes, pal-lets, container, shelves, tracks, screw boxes, packs, and cans;
Cartridges, syringes, medical applications, containers for any transportation, waste baskets and waste bins, waste bags, bins, dust bins, bin liners, wheely bins, container in general, tanks for water/used water/chemistry/gas/oil/gasoline/diesel; tank liners, boxes, crates, battery cases, troughs, medical devices such as piston, ophthalmic applications, diagnostic devices, and packing for pharmaceuticals blister;
Household articles of any kind (e.g. appliances, thermos bottle/clothes hanger), fastening systems such as plugs, wire and cable clamps, zippers, closures, locks, and snap-closures;
Support devices, articles for the leisure time such as sports and fitness devices, gymnastics mats, ski-boots, inline-skates, skis, big foot, athletic surfaces (e.g. tennis grounds); screw tops, tops and stoppers for bottles, and cans;
Furniture in general, foamed articles (cushions, impact absorbers), foams, sponges, dish clothes, mats, garden chairs, stadium seats, tables, couches, toys, building kits (boards/figures/balls), playhouses, slides, and play vehicles;
Materials for optical and magnetic data storage;
Kitchen ware (eating, drinking, cooking, storing);
Boxes for CD's, cassettes and video tapes; DVD electronic articles, office sup-plies of any kind (ball-point pens, stamps and ink-pads, mouse, shelves, tracks), bottles of any volume and content (drinks, detergents, cosmetics including perfumes), and adhesive tapes.
Footwear (shoes/shoe-soles), insoles, spats, adhesives, structural adhesives, food boxes (fruit, vegetables, meat, fish), synthetic paper, labels for bottles, couches, artificial joints (human), printing plates (flexographic), printed circuit boards, and display technologies; or
Devices of filled polymers (talc, chalk, china clay (kaolin), wollastonite, pigments, carbon black, TiO2, mica, nanocomposites, dolomite, silicates, glass, asbestos).

A shaped artificial polymer article which is a film, pipe, cable, tape, sheet, container, frame, fibre or monofilament is preferred.

Another preferred embodiment of the present invention is a thin film, typically obtained with the blow extrusion technology. A monolayer film or a multilayer film of three, five or seven layers is of particular interest. The most important application of thin plastic films in agriculture is as covers for greenhouses and tunnels to grow crops in a protected environment.

A further embodiment of the present invention is an extruded, casted, spun, molded or calendered polymer composition comprising a synthetic polymer and/or a natural or synthetic elastomer and the hybrid metal oxide microspheres as defined herein. As to such compositions the definitions and preferences given herein shall apply.

The hybrid metal oxide spheres are preferably present in the extruded, casted, spun, molded or calendered polymer composition in an amount of from 0.01 wt % to 40.0 wt %, especially 0.01 wt % to 20.0 wt %, based on the weight of the composition. More preferred is a concentration of 0.1 wt % to 20.0 wt %, especially 0.1 wt % to 10.0. Highly preferred is a concentration of 0.25 wt % to 10.0 wt %, especially 0.5 wt % to 10.0 wt %.

The extruded, casted, spun, molded or calendered polymer composition and the shaped artificial polymer article may comprise at least one further additive in an amount of from 0.001% to 30%, preferably 0.005% to 20%, in particular 0.005% to 10%, by weight, relative to the weight of the extruded, casted, spun, molded or calendered polymer composition or the article. Examples are listed below:

### Antioxidants

Alkylated monophenols, for example 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, nonylphenols which are linear or branched in the side chains, for example, 2,6-di-nonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol and mixtures thereof.

Alkylthiomethylphenols, for example 2,4-dioctylthiomethyl-6-tert-butylphenol, 2,4-dioctylthiomethyl-6-methylphenol, 2,4-dioctylthiomethyl-6-ethylphenol, 2,6-di-dodecylthiomethyl-4-nonylphenol.

Hydroquinones and alkylated hydroquinones, for example 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate.

Tocopherols, for example α-tocopherol, β-tocopherol, γ-tocopherol, δ-tocopherol and mixtures thereof (vitamin E).

Hydroxylated thiodiphenyl ethers, for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)disulfide.

Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methyl-phenyl)-3-n-dodecylmercaptobutane, ethylene glycol bis[3,3-bis(3′-tert-butyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis(3,5-di-tert-butyl-4-hydroxyphenyl)propane, 2,2-bis(5-tert-butyl-4-hydroxy2-methylphenyl)-4-n-dodecylmercaptobutane, 1,1,5,5-tetra-(5-tert-butyl-4-hydroxy-2-methylphenyl)pentane.

O-, N- and S-benzyl compounds, for example 3,5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, isooctyl-3,5-di-tert-butyl-4-hydroxybenzylmercaptoacetate.

Hydroxybenzylated malonates, for example dioctadecyl-2,2-bis(3,5-di-tert-butyl-2-hydroxybenzyl)malonate, di-octadecyl-2-(3-tert-butyl-4-hydroxy-5-methylbenzyl)malonate, di-dodecylmercaptoethyl-2,2-bis(3,5-di-tert-butyl-4-hydroxybenzyl)malonate, bis[4-(1,1,3,3-te-tramethylbutyl)phenyl]-2,2-bis(3,5-di-tert-butyl-4-hydroxybenzyl)malonate.

Aromatic hydroxybenzyl compounds, for example 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol.

Triazine compounds, for example 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)-hexahydro-1,3,5-triazine, 1,3,5-tris(3,5-dicyclohexyl-4-hydroxybenzyl)isocyanurate.

Benzylphosphonates, for example dimethyl-2,5-di-tert-butyl-4-hydroxybenzylphosphonate, diethyl-3,5-di-tert-butyl-4-hydroxybenzylphosphonate, dioctadecyl3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.

Acylaminophenols, for example 4-hydroxylauranilide, 4-hydroxystearanilide, octyl N-(3,5-di-tert-butyl-4-hydroxyphenyl)carbamate.

Esters of β-(3,5-di-tert-butyl-4-hydroxyphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

Esters of β-(5-tert-butyl-4-hydroxy-3-methylphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis-(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; 3,9-bis[2-{3-(3-tert-butyl-4-hydroxy-5-methylphenyl)propionyloxy}-1,1-dimethylethyl]-2,4,8,10-tetraoxaspiro[5.5]-undecane.

Esters of β-(3,5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

Esters of 3,5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hy-droxymethyl-1-phospha-2,6,7-trioxabicyclo[2.2.2]octane.

Amides of β-(3,5-di-tert-butyl-4-hydroxyphenyl)propionic acid e.g. N,N′-bis(3,5-di-tert-butyl-4-hydroxyphenylpropionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide (Naugard®XL-1, supplied by Uniroyal).

### Ascorbic Acid (Vitamin C)

Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octyl-phenothiazines, N-allylphenothiazine, N,N,N′,N′-tetraphenyl-1,4-diaminobut-2-ene.

### UV Absorbers and Light Stabilizers

2-(2′-Hydroxyphenyl)benzotriazoles, for example 2-(2′-hydroxy-5′-methylphenyl)-benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chloro-benzotriazole, 2-(3′-tert-butyl-2′-hydroxy-5′-methylphenyl)-5-chloro-benzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis-(α,α-dimethylbenzyl)-2′-hydroxyphenyl)benzotriazole, 2-(3′-tert-butyl-2′-hydroxy-5′-(2-octyloxycarbonylethyl)phenyl)-5-chloro-benzotriazole, 2-(3′-tert-butyl-5′-[2-(2-ethylhexyloxy)-carbonylethyl]-2′-hydroxyphenyl)-5-chloro-benzotriazole, 2-(3′-tert-butyl-2′-hydroxy-5′-(2-methoxycarbonylethyl)phenyl)-5-chloro-benzotriazole, 2-(3′-tert-butyl-2′-hydroxy-5′-(2-meth-oxycarbonylethyl)phenyl)benzotriazole, 2-(3′-tert-butyl-2′-hydroxy-5′-(2-octyloxycarbonyl-ethyl)phenyl)benzotriazole, 2-(3′-tert-butyl-5′-[2-(2-ethylhexyloxy)carbonylethyl]-2′-hydroxy-phenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300; [R—CH₂CH₂—COO—CH₂CH₂, where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)-phenyl]-benzotriazole; 2-[2′-hydroxy-3′-(1,1,3,3-tetramethylbutyl)-5′-(α,α-dimethylbenzyl)-phenyl]benzotriazole.

Hydroxybenzophenones, for example the 4-hydroxy, 4-methoxy, 4-octyloxy, 4-decyl-oxy, 4-dodecyloxy, 4-benzyloxy, 4,2′,4′-trihydroxy and 2′-hydroxy-4,4′-dimethoxy derivatives.

Esters of substituted and unsubstituted benzoic acids, for example 4-tert-butylphenyl salicylate, phenyl salicylate, octylphenyl salicylate, dibenzoyl resorcinol, bis(4-tert-butylben-zoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

Acrylates, for example ethyl α-cyano-β,β-diphenylacrylate, isooctyl α-cyano-β,β-diphenylacrylate, methyl α-carbomethoxycinnamate, methyl α-cyano-β-methyl-p-methoxycinnamate, butyl α-cyano-β-methyl-p-methoxy-cinnamate, methyl α-carbomethoxy-p-methoxycinnamate, N—(α-carbomethoxy-α-cyanovinyl)-2-methylindoline, neopentyl tetra(α-cyano-β,β-diphenylacrylate.

Nickel compounds, for example nickel complexes of 2,2′-thio-bis[4-(1,1,3,3-tetramethylbutyl)phenol], such as the 1:1 or 1:2 complex, with or without additional ligands such as n-butylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert-butylbenzylphosphonic acid, nickel complexes of ketoximes, e.g. of 2-hydroxy-4-methylphe-nylundecylketoxime, nickel complexes of 1-phenyl-4-lauroyl-5-hydroxypyrazole, with or without additional ligands.

Sterically hindered amines, for example carbonic acid bis(1-undecyloxy-2,2,6,6-tetramethyl-4-piperidyl)ester, bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanediyl)-bis(3,3,5,5-tetrame-thylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)-malonate, 3-n-octyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperidyl)hexamethylenediamine and 4-cyclohexylamino-2,6-dichloro-1,3,5-triazine, a condensate of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); a condensate of 1,6-hexanediamine and 2,4,6-trichloro-1,3,5-triazine as well as N,N-dibutylamine and 4-butylamino-2,2,6,6-tetramethylpiperidine (CAS Reg. No. [192268-64-7]); N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxypiperidine, poly[methylpropyl-3-oxy-4-(2,2,6,6-tetramethyl-4-piperidyl)]siloxane, a reaction product of maleic acid anhydride-α-olefin copolymer with 2,2,6,6-tetramethyl-4-aminopiperidine or 1,2,2,6,6-pentamethyl-4-aminopiperidine, 2,4-bis[N-(1-cyclohexyloxy-2,2,6,6-tetramethylpiperidine-4-yl)-N-butylamino]-6-(2-hydroxyethyl)amino-1,3,5-triazine, 1-(2-hydr-oxy-2-methylpropoxy)-4-octadecanoyloxy-2,2,6,6-tetramethylpiperidine, 5-(2-ethylhexanoyl)-oxymethyl-3,3,5-trimethyl-2-morpholinone, Sanduvor (Clariant; CAS Reg. No. 106917-31-1], 5-(2-ethylhexanoyl)oxymethyl-3,3,5-trimethyl-2-morpholinone, the reaction product of 2,4-bis[(1-cyclohexyloxy-2,2,6,6-piperidine-4-yl)butylamino]-6-chloro-s-triazine with N,N′-bis(3-ami-nopropyl)ethylenediamine), 1,3,5-tris(N-cyclohexyl-N-(2,2,6,6-tetramethylpiperazine-3-one-4-yl)amino)-s-triazine, 1,3,5-tris(N-cyclohexyl-N-(1,2,2,6,6-pentamethylpiperazine-3-one-4-yl)-amino)-s-triazine,

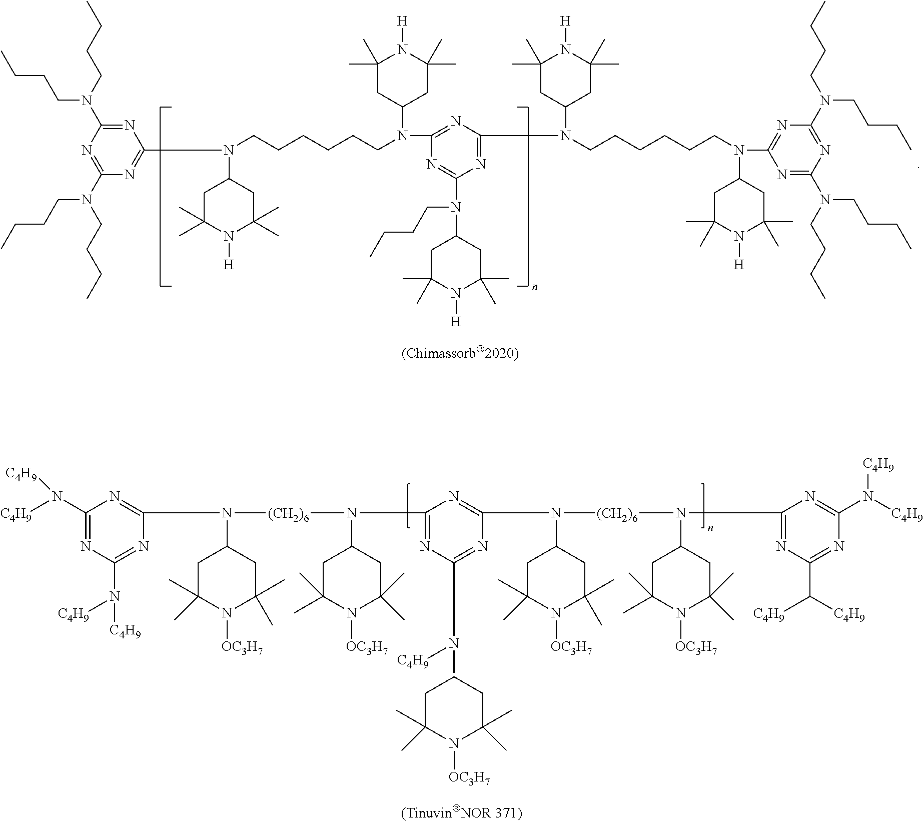

1,3,5-Triazine-2,4,6-triamine, N,N′″-1,6-hexanediylbis[N′,N″-dibutyl-N,N′,N″-tris(2,2,6,6-tetramethyl-4-piperidinyl)-reaction products with 3-bromo-1-propene, oxidized, hydrogenated, 1,3,5-Triazine-2,4,6-triamine, N,N′″-1,6-hexanediylbis[N′,N″-dibutyl-N,N′,N″-tris(2,2,6,6-tetramethyl-4-piperidinyl)-, 4-Piperidinol, 2,2,6,6-tetramethyl-1-(undecyloxy)-, 4,4′-carbonate, 1,3,5-Triazine-2,4,6-triamine, N2,N2′-1,6-hexanediylbis[N4,N6-dibutyl-N2,N4,N6-tris(2,2,6,6-tetramethyl-4-piperidinyl)-, N-allyl derives, oxidized, hydrogenated and combinations thereof.

Oxamides, for example 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

2-(2-Hydroxyphenyl)-1,3,5-triazines, for example 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine, 2,4-bis(4-[2-ethylhexyloxy]-2-hydroxyphenyl)-6-(4-methoxyphenyl)-1,3,5-triazine, 2-(4,6-bis-biphenyl-4-yl-1,3,5-triazin-2-yl)-5-(2-ethyl-(n)-hexyloxy)phenol; dodecanedioic acid, 1,12-bis[2-[4-(4,6-diphenyl-1,3,5-triazin-2-yl)-3-hydroxyphenoxy]ethyl]ester (CAS No. 1482217-03-7).

Metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.

Phosphites and phosphonites, for example triphenyl phosphite, diphenylalkyl phosphites, phenyldialkyl phosphites, tris(nonylphenyl) phosphite, trilauryl phosphite, trioctadecyl phosphite, distearylpentaerythritol diphosphite, tris(2,4-di-tert-butylphenyl) phosphite, diisodecyl pentaerythritol diphosphite, bis(2,4-di-tert-butylphenyl)pentaerythritol diphosphite, bis(2,4-di-cumylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl)pentaerythritol diphosphite, bis(2,4,6-tris(tert-butylphenyl)pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-12H-dibenz[d,g]-1,3,2-dioxaphosphocin, bis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-12-methyl-dibenz[d,g]-1,3,2-dioxaphosphocin, 2,2′,2″-nitrilo[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane, phosphorous acid, mixed 2,4-bis(1,1-dimethylpropyl)phenyl and 4-(1,1-dimethylpropyl)phenyl triesters (CAS No. 939402-02-5), Phosphorous acid, triphenyl ester, polymer with alpha-hydro-omega-hydroxypoly[oxy(methyl-1,2-ethanediyl)], C10-16 alkyl esters (CAS No. 1227937-46-3).

The following phosphites are especially preferred:

Tris(2,4-di-tert-butylphenyl) phosphite (Irgafos®168, Ciba Specialty Chemicals Inc.), tris(nonylphenyl) phosphite,

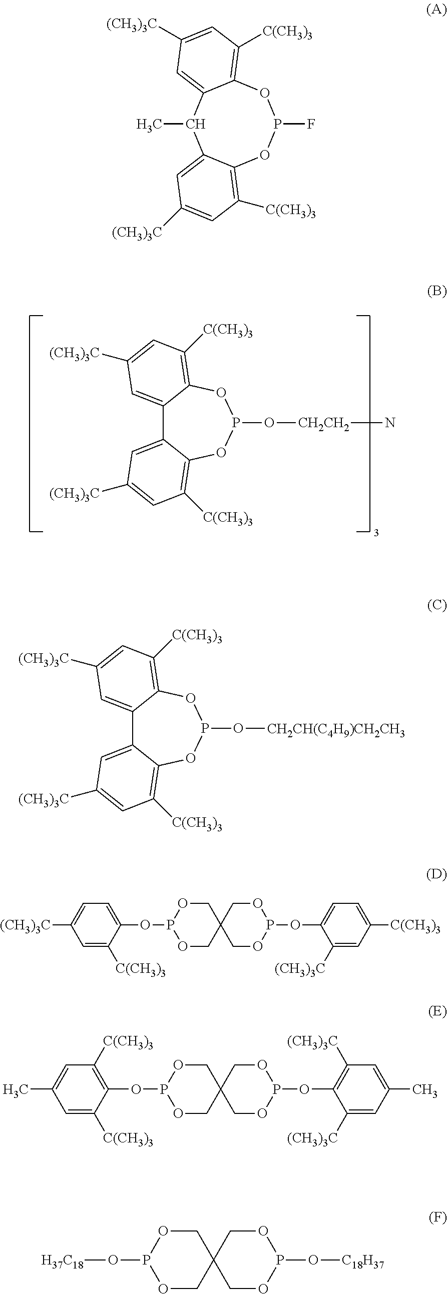

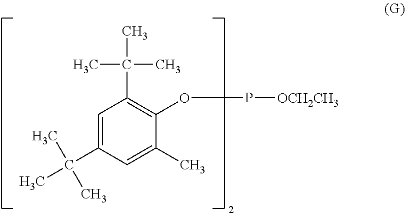

Hydroxylamines, for example N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N,N-dialkylhydroxylamine derived from hydrogenated tallow amine.

Nitrones, for example, N-benzyl-alpha-phenylnitrone, N-ethyl-alpha-methylnitrone, N-octyl-alpha-heptylnitrone, N-lauryl-alpha-undecylnitrone, N-tetradecyl-alpha-tridecylnnitrone, N-hexadecyl-alpha-pentadecylnitrone, N-octadecyl-alpha-heptadecylnitrone, N-hexadecyl-alpha-heptadecylnitrone, N-ocatadecyl-alpha-pentadecylnitrone, N-heptadecyl-alpha-heptadecylnitrone, N-octadecyl-alpha-hexadecylnitrone, nitrone derived from N,N-dialkylhydroxylamine derived from hydrogenated tallow amine.

Thiosynergists, for example dilauryl thiodipropionate, dimistryl thiodipropionate, distearyl thiodipropionate, pentaerythritol tetrakis[3-(dodecylthio)prop]onate] or distearyl disulfide.

Peroxide scavengers, for example esters of β-thiodipropionic acid, for example the lauryl, stearyl, myristyl or tridecyl esters, mercaptobenzimidazole or the zinc salt of 2-mercaptobenzimidazole, zinc dibutyldithiocarbamate, dioctadecyl disulfide, pentaerythritol tetrakis(β-dodecylmercapto)propionate.

Polyamide stabilizers, for example copper salts in combination with iodides and/or phosphorus compounds and salts of divalent manganese.

Basic co-stabilizers, for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate.

PVC heat stabilizer, for example, mixed metal stabilizers (such as Barium/Zinc, Calcium/Zinc type), Organotin stabilizers (such as organo tin mercaptester, -carboxylate, -sulfide), Lead stabilizers (such as Tribasic lead sulfate, Dibasic lead stearate, Dibasic lead phthalate, Dibasic lead phosphate, lead stearate), organic based stabilizers and combinations thereof.

Nucleating agents, for example inorganic substances, such as talcum, metal oxides, such as titanium dioxide or magnesium oxide, phosphates, carbonates or sulfates of, preferably, alkaline earth metals; organic compounds, such as mono- or polycarboxylic acids and the salts thereof, e.g. 4-tert-butylbenzoic acid, adipic acid, diphenylacetic acid, sodium succinate or sodium benzoate; polymeric compounds, such as ionic copolymers (ionomers). Especially preferred are 1,3:2,4-bis(3′,4′-dimethylbenzylidene)sorbitol, 1,3:2,4-di(paramethyl-dibenzylidene)sorbitol, and 1,3:2,4-di(benzylidene)sorbitol.

Fillers and reinforcing agents, for example calcium carbonate, silicates, glass fibres, glass beads, asbestos, talc, kaolin, mica, barium sulfate, metal oxides and hydroxides, carbon black, graphite, wood flour and flours or fibers of other natural products, synthetic fibers.

Plasticizer, wherein said plasticizer is selected from the group consisting of Di(2-ethylhexyl) phthalate, Disononyl phthalate, Diisodecyl phthalate, Dipropylheptyl phthalate, Trioctyl trimellitate, Tri(isononyl) trimellitate, epoxidized soy bean oil, Di(isononyl) cyclohexane-1,2-dicarboxcylate, 2,4,4-Trimethyl-1,3-pentaediol diisobutyrate.

The plasticizer as used in accordance with the invention may also comprise one selected from the group consisting of: phthalates, trimellitates, aliphatic dibasic esters, polyesters, polymeric, epoxides, phosphates. In a preferred embodiment said plasticizer is selected from the group consisting of: Butyl benzyl phthalate, Butyl 2-ethylhexyl phthalate, Diisohexyl phthalate, Diisoheptyl phthalate, Di(2-ethylhexyl) phthalate, Diisooctyl phthalate, Di-n-octyl phthalate, Disononyl phthalate, Diisodecyl phthalate, Diiso undecyl phthalate, Diisotredecyl phthalate, Diiso (C11, C12, C13) phthalate, Di(n-butyl) phthalate, Di(n-C7, C9) phthalate, Di(n-C6, C8, C10) phthalate, Diiso(n-nonyl) phthalate, Di(n-C7, C9, C11) phthalate, Di(n-C9, C11) phthalate, Di(n-undecyl) phthalate, Tri(n-C8, C10) trimellitate, Tri(2-ethylhexyl) trimellitate, Tri(isooctyl) trimellitate, Tri(isononyl) trimellitate, Di(n-C7, C9) adipate, Di(2-ethylhexyl) adipate, Di(isooctyl) adipate, Di(isononyl) adipate, Polyesters of adipinic acid or glutaric acid and propylene glycol or butylene glycol or 2,2-dimethyl-1,3-propanediol, Epoxidized oils such as epoxidized soy bean oil, epoxidized linseed oil, epoxidized tall oil, Octyl epoxy tallate, 2-ethylhexyl epoxy tallate, Isodecyl diphenyl phosphate, Tri(2-ethylhexyl) phosphate, Tricresyl phosphate, Di(2-ethylhexyl) terephthalate, Di(isononyl) cyclohexane-1,2-dicarboxcylate and combinations thereof. In a particularly preferred embodiment said plasticizer is selected from the group consisting of: Diisohexyl phthalate, Diisoheptyl phthalate, Di(2-ethylhexyl) phthalate, Diisooctyl phthalate, Di-n-octyl phthalate, Disononyl phthalate, Diisodecyl phthalate, Diiso undecyl phthalate, Diisotredecyl phthalate, Diiso (C11, C12, C13) phthalate, Di(n-butyl) phthalate, Di(n-C7, C9) phthalate, Di(n-C6, C8, C10) phthalate, Diiso(n-nonyl) phthalate, Di(n-C7, C9, C11) phthalate, Di(n-C9, C11) phthalate, Di(n-undecyl) phthalate, Tri(n-C8, C10) trimellitate, Tri(2-ethylhexyl) trimellitate, Tri(isooctyl) trimellitate, Tri(isononyl) trimellitate, Di(n-C7, C9) adipate, Di(2-ethylhexyl) adipate, Di(isooctyl) adipate, Di(isononyl) adipate, Polyesters of adipinic acid or glutaric acid and propylene glycol or butylene glycol or 2,2-dimethyl-1,3-propanediol, Epoxidized oils such as epoxidized soy bean oil, Di(isononyl) cyclohexane-1,2-dicarboxcylate and combinations thereof.

Other additives, for example plasticisers, lubricants, emulsifiers, pigments, rheology additives, catalysts, flow-control agents, optical brighteners, flameproofing agents, antistatic agents and blowing agents.

Benzofuranones and indolinones, for example those disclosed in U.S. Pat. Nos. 4,325,863; 4,338,244; 5,175,312; 5,216,052; 5,252,643; DE-A-4316611; DE-A-4316622; DE-A-4316876; EP-A-0589839, EP-A-0591102; EP-A-1291384 or 3-[4-(2-acetoxyethoxy)phenyl]-5,7-di-tert-butylbenzofuran-2-one, 5,7-di-tert-butyl-3-[4-(2-stearoyloxy-ethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-di-methylphenyl)-5,7-di-tert-butylbenzofuran-2-one, 3-(3,5-dimethyl-4-pivaloyloxyphenyl)-5,7-di-tert-butylbenzofuran-2-one, 3-(3,4-dimethylphenyl)-5,7-di-tert-butylbenzofuran-2-one, 3-(2,3-dimethylphenyl)-5,7-di-tert-butylbenzofuran-2-one, 3-(2-acetyl-5-isooctylphenyl)-5-isooctyl-benzofuran-2-one.

In certain embodiments, the photonic material disclosed herein with UV absorption functionality can be coated on or incorporated into a substrate, e.g., plastics, wood, fibers or fabrics, ceramics, glass, metals and composite products thereof

The scope and interest of the invention will be better understood based on the following examples which are intended to illustrate certain embodiments of the invention and are non-limitative.

### ILLUSTRATIVE EXAMPLES

The following examples are set forth to assist in understanding the disclosed embodiments and should not be construed as specifically limiting the embodiments described and claimed herein. Such variations of the embodiments, including the substitution of all equivalents now known or later developed, which would be within the purview of those skilled in the art, and changes in formulation or minor changes in experimental design, are to be considered to fall within the scope of the embodiments incorporated herein.

### Example 1: Hybrid Titania Silica Microspheres with Angle-Dependent Ordered Structure

An aqueous suspension of 180 nm spherical silica nanoparticles and 5 nm titania nanoparticles was prepared, which contained 1.8 wt % of the silica nanoparticles and 1.2 wt % of the titania nanoparticles based on a total weight of the aqueous suspension. The aqueous suspension was spray dried under an inert atmosphere (nitrogen) at a 100° C. inlet temperature, a 40 mm spray gas pressure, a 100% aspirator rate, and a 30% flow rate (about 10 mL/min) using a BUCHI lab-scale spray dryer.

The spray dried powder was removed from the spray dryer's collection chamber and spread onto a silicon wafer for sintering. The spray dried powder was then calcined in a muffle furnace with a batch sintering process to densify and stabilize the microspheres. The heating parameters were as follows: the particles were heated from room temperature to 550° C. over a period of 12 hours, held at 550° C. for 2 hours, and then cooled back to room temperature over a period of 3 hours.

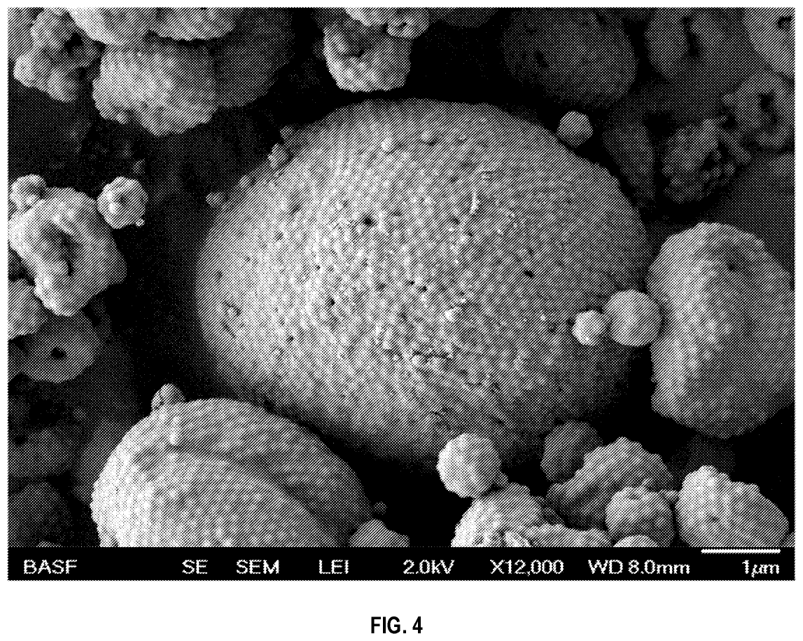

FIG. 4 is an SEM image of hybrid metal oxide particles corresponding to Example 1.

### Example 2: Disordered Hybrid Silica Titania Microspheres

An aqueous suspension of 180 nm spherical silica nanoparticles, 160 nm spherical silica nanoparticles, and 5 nm titania nanoparticles was prepared, which contained 1.2 wt % of the 180 nm silica nanoparticles, 0.6 wt % of the 160 nm silica nanoparticles, and 1.2 wt % of the titania nanoparticles based on a total weight of the aqueous suspension. The aqueous suspension was spray dried under an inert atmosphere (nitrogen) at a 100° C. inlet temperature, a 40 mm spray gas pressure, a 100% aspirator rate, and a 30% flow rate (about 10 mL/min) using a BUCHI lab-scale spray dryer.

The spray dried powder was removed from the spray dryer's collection chamber and spread onto a silicon wafer for sintering. The spray dried powder was then calcined in a muffle furnace with a batch sintering process to densify and stabilize the microspheres. The heating parameters were as follows: the particles were heated from room temperature to 550° C. over a period of 7 hours, held at 550° C. for 2 hours, and then cooled back to room temperature over a period of 4 hours.

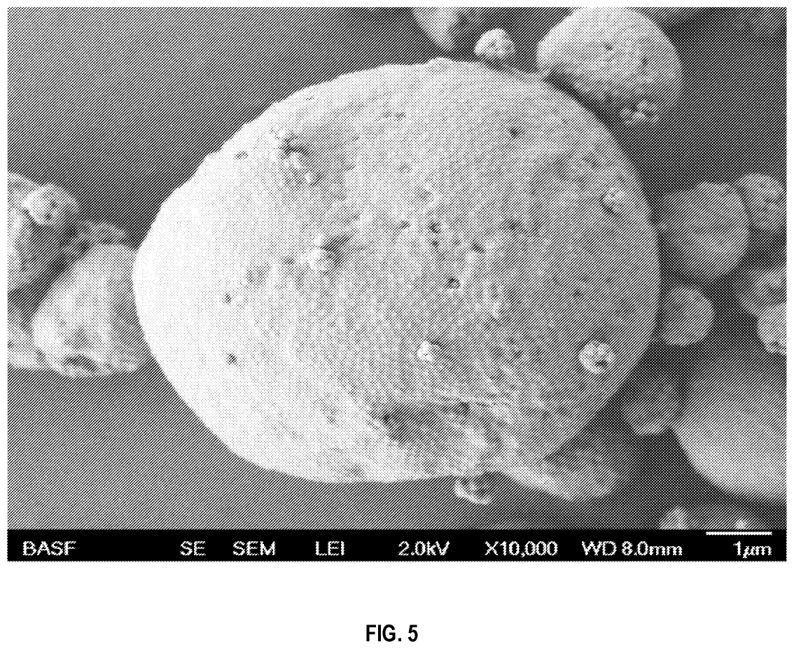

FIG. 5 is an SEM image of hybrid metal oxide particles corresponding to Example 2, demonstrating the presence of disordered template (silica) nanoparticles.

The disordered microspheres display an angle independent blue coloration when dispersed in mineral oil with 1 wt % carbon black per mass of colorant.

### Example 3: Hybrid Zinc Oxide Silica Microspheres Produced Via a Sol-Gel Process

An aqueous suspension of 135 nm zinc oxide nanoparticles was prepared, which contained 1.8 wt % of the 135 nm zinc oxide nanoparticles based on a total weight of the aqueous suspension. TEOS was then dissolved in the suspension at a concentration of 17.4 mg/mL. The aqueous suspension was spray dried under an inert atmosphere (nitrogen) at a 100° C. inlet temperature, a 40 mm spray gas pressure, a 100% aspirator rate, and a 30% flow rate (about 10 mL/min) using a BUCHI lab-scale spray dryer.

The spray dried powder was removed from the spray dryer's collection chamber and spread onto a silicon wafer for sintering. The spray dried powder was then calcined in a muffle furnace with a batch sintering process to densify and stabilize the microspheres. The heating parameters were as follows: the particles were heated from room temperature to 500° C. over a period of 4 hours, held at 500° C. for 2 hours, and then cooled back to room temperature over a period of 4 hours.

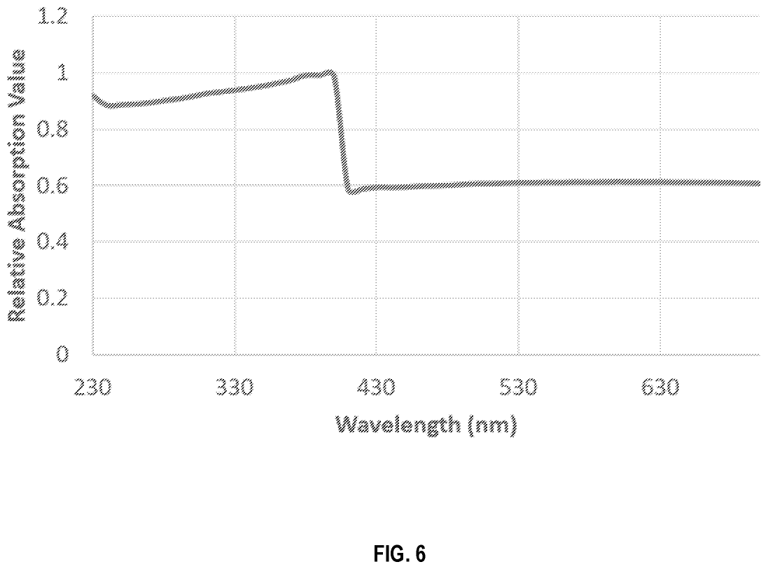

2.5 mg of the microspheres were suspended in 100 mL of acetone and serially diluted in a UV-transparent 96-well plate. The suspensions were dried into powder films and relative attenuation of UV light was measured via a plate reader. The sample exhibited increased attenuation in the UV range as evidenced by a reduction in UV transmission, expressed as a relative absorption value. FIG. 6 is a plot of attenuation across the UV-vis spectrum of a sample of Example 3, showing increased relative attenuation in the UV range.

### Example 4: Hybrid Alumina Silica Microspheres

An aqueous suspension of 300 nm spherical alumina nanoparticles and 5 nm silica nanoparticles was prepared, which contained 1.8 wt % of the 300 nm alumina nanoparticles and 1.2 wt % of the 5 nm silica nanoparticles based on a total weight of the aqueous suspension. The aqueous suspension was spray dried under an inert atmosphere (nitrogen) at a 100° C. inlet temperature, a 40 mm spray gas pressure, a 100% aspirator rate, and a 30% flow rate (about 10 mL/min) using a BUCHI lab-scale spray dryer.

The spray dried powder was removed from the spray dryer's collection chamber and spread onto a silicon wafer for sintering. The spray dried powder was then calcined in a muffle furnace with a batch sintering process to densify and stabilize the microspheres. The heating parameters were as follows: the particles were heated from room temperature to 500° C. over a period of 4 hours, held at 500° C. for 2 hours, and then cooled back to room temperature over a period of 4 hours.

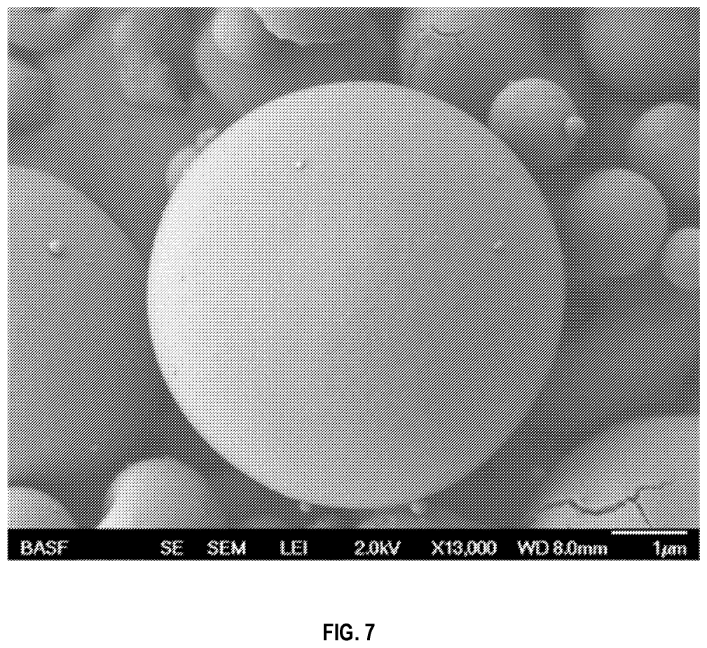

FIG. 7 is an SEM image of hybrid metal oxide particles corresponding to Example 4.

### Prophetic Application Examples 1 to 3

Polypropylene powder (Profax 6301, 12 g/10 min melt flow rate) is weighed in a 240 ml cup. An antioxidant (Irganox B 215) and the hybrid particles of any of the above examples are weighed and mixed with the powder. The weights of the components for each sample are listed in Table 1, below.

TABLE 1
Weight and concentration of the components

| Application | Polypropylene, | Antioxidant, | Hybrid |
|---|---|---|---|
| Example | g | g | particles, g |
| 1 | 49.95 | 0.05 | — |
| 2 | 49.7 | 0.05 | 0.25 |
| 3 | 49.2 | 0.05 | 0.75 |

The polymer mixture is placed in a preheated C. W. Brabender Plasti-Corder at 210° C. and mixed for three minutes at 50 rpm to achieve a homogenous molten mixture. The molten polymer is then compression molded to a thickness of 250 μm at 218° C. for three minutes under low pressure followed by three minutes under high pressure. The mold is then cooled in the compression molder for three minutes. A 5 cm×5 cm square is cut from the sheet for UV-Vis measurement.

### Irganox B215 is a Mixture of the Compounds of Formulae

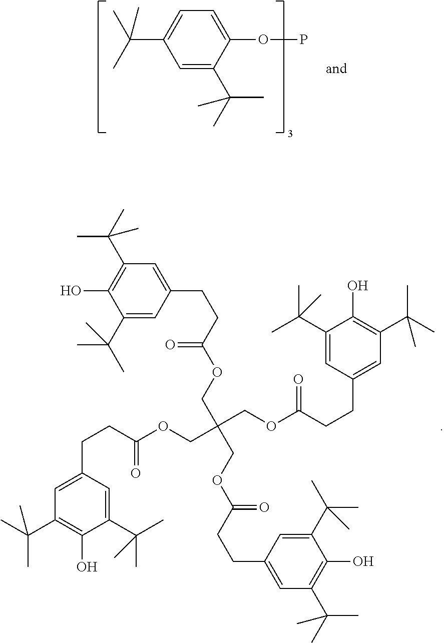

### Prophetic Application Examples 4 to 7

Polypropylene powder (Profax 6301, 12 g/10 min melt flow rate) is weighed in a 240 ml cup. An antioxidant (Irganox B 215), ultraviolet light absorber (Tinuvin® PA 328), and the hybrid particles of any of the above examples are weighed and mixed with the powder. The weights of the components for each sample are listed in Table 2, below.

TABLE 2
Weight and concentration of the components

| | | | Ultraviolet | Hybrid |
|---|---|---|---|---|
| Sample | Polypropylene, | Antioxidant, | Light | particles, |
| Number | g | g | Absorber, g | g |
| 4 | 49.95 | 0.05 | — | — |
| 5 | 49.9 | 0.05 | 0.05 | — |
| 6 | 49.65 | 0.05 | 0.05 | 0.25 |
| 7 | 49.15 | 0.05 | 0.05 | 0.75 |

The polymer mixture is placed in a preheated C. W. Brabender Plasti-Corder at 210° C. and mixed for three minutes at 50 rpm to achieve a homogenous molten mixture. The molten polymer is then compression molded to a thickness of 250 μm at 218° C. for three minutes under low pressure followed by three minutes under high pressure. The mold is then cooled in the compression molder for three minutes. A 5 cm×5 cm square is cut from the sheet for UV-Vis measurement.

### Tinuvin® PA 328 is the Compound of Formula

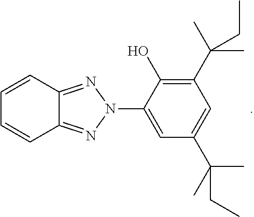 [SMILES: CCC(C)(C)c1cc(-n2nc3ccccc3n2)c(O)c(C(C)(C)CC)c1]

### Prophetic Application Examples 8 and 9

Polypropylene powder (Profax 6301, 12 g/10 min melt flow rate) is weighed in a 240 ml cup. An antioxidant (Irganox B 215), ultraviolet light absorber (Tinuvin® 326), and the hybrid particles of any of the above examples are weighed and mixed with the powder. The weights of the components for each sample are listed in Table 3, below.

TABLE 3
Weight and concentration of the components

| | | | Ultraviolet | Hybrid |
|---|---|---|---|---|
| Sample | Polypropylene, | Antioxidant, | Light | particles, |
| Number | g | g | Absorber, g | g |
| 8 | 49.9 | 0.05 | 0.05 | — |
| 9 | 49.15 | 0.05 | 0.05 | 0.75 |

The polymer mixture is placed in a preheated C. W. Brabender Plasti-Corder at 210° C. and mixed for three minutes at 50 rpm to achieve a homogenous molten mixture. The molten polymer is then compression molded to a thickness of 250 μm at 218° C. for three minutes under low pressure followed by three minutes under high pressure. The mold is then cooled in the compression molder for three minutes. A 5 cm×5 cm square is cut from the sheet for UV-Vis measurement.

### Tinuvin 326® is the Compound of Formula

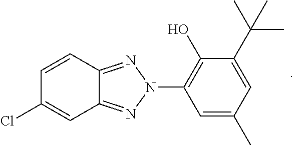 [SMILES: Cc1cc(-n2nc3ccc(Cl)cc3n2)c(O)c(C(C)(C)C)c1]

### Prophetic Application Examples 10 and 11

Polypropylene powder (Profax 6301, 12 g/10 min melt flow rate) is weighed in a 240 ml cup. An antioxidant (Irganox B 215), ultraviolet light absorber (Chimassorb® 81), and the hybrid particles of any of the above examples are weighed and mixed with the powder. The weights of the components for each sample are listed in Table 4, below.

TABLE 4
Weight and concentration of the components

| | | | Ultraviolet | Hybrid |
|---|---|---|---|---|
| Sample | Polypropylene, | Antioxidant, | Light | particles, |
| Number | g | g | Absorber, g | g |
| 10 | 49.9 | 0.05 | 0.05 | — |
| 11 | 49.15 | 0.05 | 0.05 | 0.75 |

The polymer mixture is placed in a preheated C. W. Brabender Plasti-Corder at 210° C. and mixed for three minutes at 50 rpm to achieve a homogenous molten mixture. The molten polymer is then compression molded to a thickness of 250 μm at 218° C. for three minutes under low pressure followed by three minutes under high pressure. The mold is then cooled in the compression molder for three minutes. A 5 cm×5 cm square is cut from the sheet for UV-Vis measurement.

### Chimassorb® 81 is the Compound of Formula

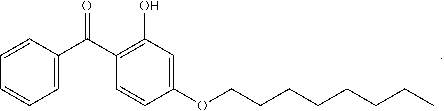 [SMILES: CCCCCCCCOc1ccc(C(=O)c2ccccc2)c(O)c1]

### Prophetic Application Examples 12 and 13

Polypropylene powder (Profax 6301, 12 g/10 min melt flow rate) is weighed in a 240 ml cup. An antioxidant (Irganox B 215), ultraviolet light absorber (Tinuvin® 1577), and the hybrid particles of any of the above examples are weighed and mixed with the powder. The weights of the components for each sample are listed in Table 5, below.

TABLE 5
Weight and concentration of the components

| | | | Ultraviolet | Hybrid |
|---|---|---|---|---|
| Sample | Polypropylene, | Antioxidant, | Light | particles, |
| Number | g | g | Absorber, g | g |
| 12 | 49.9 | 0.05 | 0.05 | — |
| 13 | 49.15 | 0.05 | 0.05 | 0.75 |

The polymer mixture is placed in a preheated C. W. Brabender Plasti-Corder at 210° C. and mixed for three minutes at 50 rpm to achieve a homogenous molten mixture. The molten polymer is then compression molded to a thickness of 250 μm at 218° C. for three minutes under low pressure followed by three minutes under high pressure. The mold is then cooled in the compression molder for three minutes. A 5 cm×5 cm square is cut from the sheet for UV-Vis measurement.

### Tinuvin 1577@ is the Compound of Formula

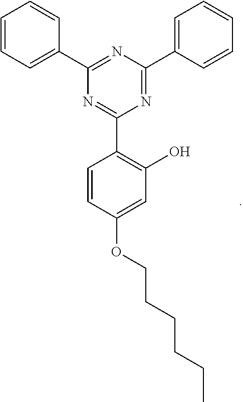 [SMILES: CCCCCCOc1ccc(-c2nc(-c3ccccc3)nc(-c3ccccc3)n2)c(O)c1]

### Prophetic Application Examples 14 and 15

Polypropylene powder (Profax 6301, 12 g/10 min melt flow rate) is weighed in a 240 ml cup. An antioxidant (Irganox B 215), ultraviolet light absorber (Uvinul® 3035), and the hybrid particles of any of the above examples are weighed and mixed with the powder. The weights of the components for each sample are listed in Table 6, below.

TABLE 6
Weight and concentration of the components

| | | | Ultraviolet | Hybrid |
|---|---|---|---|---|
| Sample | Polypropylene, | Antioxidant, | Light | particles, |
| Number | g | g | Absorber, g | g |
| 14 | 49.9 | 0.05 | 0.05 | — |
| 15 | 49.15 | 0.05 | 0.05 | 0.75 |

The polymer mixture is placed in a preheated C. W. Brabender Plasti-Corder at 210° C. and mixed for three minutes at 50 rpm to achieve a homogenous molten mixture. The molten polymer is then compression molded to a thickness of 250 μm at 218° C. for three minutes under low pressure followed by three minutes under high pressure. The mold is then cooled in the compression molder for three minutes. A 5 cm×5 cm square is cut from the sheet for UV-Vis measurement.

### Uvinul 3035® is the Compound of Formula

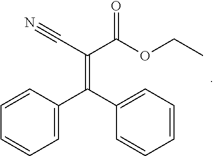 [SMILES: CCOC(=O)C(C#N)=C(c1ccccc1)c1ccccc1]

### Prophetic Application Examples 16 and 17

Polyethylene powder (Microthene MN 700 LDPE, 20 g/10 min melt flow rate) is weighed in a 240 ml cup. An antioxidant (Irganox B 215), ultraviolet light absorber (Tinuvin® 326), and the hybrid particles of any of the above examples are weighed and mixed with the powder. The weights of the components for each sample are listed in Table 7, below.

TABLE 7
Weight and concentration of the components

| | | | Ultraviolet | Hybrid |
|---|---|---|---|---|
| Sample | Polyethylene, | Antioxidant, | Light | particles, |
| Number | g | g | Absorber, g | g |
| 16 | 49.9 | 0.05 | 0.05 | — |
| 17 | 49.15 | 0.05 | 0.05 | 0.75 |

The polymer mixture is placed in a preheated C. W. Brabender Plasti-Corder at 210° C. and mixed for three minutes at 50 rpm to achieve a homogenous molten mixture. The molten polymer is then compression molded to a thickness of 250 μm at 218° C. for three minutes under low pressure followed by three minutes under high pressure. The mold is then cooled in the compression molder for three minutes. A 5 cm×5 cm square is cut from the sheet for UV-Vis measurement.

### Prophetic Application Examples 18 and 19

Polyethylene powder (Microthene MN 700 LDPE, 20 g/10 min melt flow rate) is weighed in a 240 ml cup. An antioxidant (Irganox B 215), ultraviolet light absorber (Chimassorb® 81), and the hybrid particles of any of the above examples are weighed and mixed with the powder. The weights of the components for each sample are listed in Table 8, below.

TABLE 8
Weight and concentration of the components

| | | | Ultraviolet | Hybrid |
|---|---|---|---|---|
| Sample | Polyethylene, | Antioxidant, | Light | particles, |
| Number | g | g | Absorber, g | g |
| 18 | 49.9 | 0.05 | 0.05 | — |
| 19 | 49.15 | 0.05 | 0.05 | 0.75 |

The polymer mixture is placed in a preheated C. W. Brabender Plasti-Corder at 210° C. and mixed for three minutes at 50 rpm to achieve a homogenous molten mixture. The molten polymer is then compression molded to a thickness of 250 μm at 218° C. for three minutes under low pressure followed by three minutes under high pressure. The mold is then cooled in the compression molder for three minutes. A 5 cm×5 cm square is cut from the sheet for UV-Vis measurement.

### Prophetic Elongation at Break

The samples of the application examples can be exposed in an Atlas Weather-O-Meter (WOM, as per ASTM G155, 0.35 W/m2 at 340 nm, dry cycle), for accelerated light weathering. Specimens of the film samples are taken at defined intervals of time after exposure and undergo tensile testing. The residual tensile strength is measured, by means of a Zwick© Z1.0 constant velocity tensiometer (as per modified ISO 527), in order to evaluate the decay of the mechanical properties of the samples, as a consequence of the polymer degradation after its oxidation.

### Additional Prophetic Example 1

Parameters: Average microsphere diameter: 1-10 μm; Average pore diameter: 150-180 nm; Hybrid metal oxide matrix: Silica/TiO2 microsphere; Method/technology used: cast film; Amount of microsphere usage: 1.5 wt %; Organic light absorber: None; Polymer in use: Plexi-glas DR 101; Performance data: UV-vis transmittance curve.

### Additional Prophetic Example 2

Parameters: Average microsphere diameter: 1-10 μm; Average pore diameter: 150-180 nm; Hybrid metal oxide matrix: Silica/TiO2 microsphere; Method/technology used: cast film; Amount of microsphere usage: 1.5 wt %; Organic light absorber: 0.1 wt % Tinuvin 326; Polymer in use: Plexi-glas DR 101; Performance data: UV-vis transmittance curve.

### Additional Prophetic Example 3

Parameters: Average microsphere diameter: 1-10 μm; Average pore diameter: 150-180 nm; Hybrid metal oxide matrix: Silica/TiO2 microsphere; Method/technology used: twin-screw extrusion; Amount of microsphere usage: 1.5 wt %; Organic light absorber: 0.1 wt % Tinuvin 326; Polymer in use: Homo polypropylene PP 6301; Performance data: UV-vis transmittance curve and accelerated weathering results table

Analytical testing methods of an article of the present invention can be performed with, e.g., UV-vis for UV transmittance or absorbance analysis, SEM or TEM for characterizations of microspheres in polymer film matrix, QUV and Xeon weatherometer for accelerated weathering test, long term weathering test via outdoor panels or a combination thereof.

In the foregoing description, numerous specific details are set forth, such as specific materials, dimensions, processes parameters, etc., to provide a thorough understanding of the embodiments of the present disclosure. The particular features, structures, materials, or characteristics may be combined in any suitable manner in one or more embodiments. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion.

As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

Reference throughout this specification to “an embodiment,” “certain embodiments,” or “one embodiment” means that a particular feature, structure, or characteristic described in connection with the embodiment is included in at least one embodiment. Thus, the appearances of the phrase “an embodiment,” “certain embodiments,” or “one embodiment” in various places throughout this specification are not necessarily all referring to the same embodiment, and such references mean “at least one.”

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

1. A method of preparing a composition comprising incorporating hybrid metal oxide particles into a polymer, wherein the hybrid metal oxide particles are prepared by a method comprising:
generating liquid droplets from a particle dispersion comprising first metal oxide particles and second metal oxide particles;
drying the liquid droplets to provide dried particles comprising a discrete matrix of the first metal oxide particles embedded with the second metal oxide particles; and
heating the dried particles to obtain the hybrid metal oxide particles comprising a continuous matrix formed from the first metal oxide particles embedded with an array of the second metal oxide particles, wherein the hybrid metal oxide particles are present in an amount of 0.1 wt % to about 40 wt %.

2. The method of claim 1, wherein the hybrid metal oxide particles are substantially non-porous.

3. The method of claim 1, wherein heating the dried particles comprises sintering or calcining the dried particles to form the continuous matrix by densifying the first metal oxide particles.

4. The method of claim 1, wherein the liquid droplets further comprise a binder, and wherein heating the dried particles facilitates forming the continuous matrix from the binder and the first metal oxide particles.

5. The method of claim 4, wherein the binder comprises a material selected from silica, sodium silicate, magnesium silicate, calcium silicate, aluminum silicate, aluminum oxide hydroxide, sodium oxide, calcium carbonate, calcium aluminate, bentonite, kaolinite, montmorillonite, and combinations thereof.

6. The method of claim 1, wherein the first metal oxide particles and the second metal oxide particles independently comprise a metal oxide selected from silica, titania, alumina, zirconia, ceria, iron oxides, zinc oxide, indium oxide, tin oxide, chromium oxide, and combinations thereof.

7. The method of claim 1, wherein the first metal oxide particles comprise titania.

8. The method of claim 1, wherein the first metal oxide particles have an average diameter from about 1 nm to about 120 nm.

9. The method of claim 1, wherein the second metal oxide particles comprise silica.

10. The method of claim 1, wherein the second metal oxide particles have an average diameter from about 50 nm to about 999 nm.

11. The method of claim 1, wherein one or more of the first metal oxide particles or the second metal oxide particles comprise a core-shell structure.

12. The method of claim 1, wherein the second metal oxide particles are spherical metal oxide particles.

13. The method of claim 1, wherein one or more of the first metal oxide particles or the second metal oxide particles comprise a surface functionalization.

14. The method of claim 1, wherein the hybrid metal oxide particles comprise a surface functionalization.

15. The method of claim 13, wherein the surface functionalization comprises a silane.

16. The method of claim 1, wherein the hybrid metal oxide particles have an average diameter from about 0.5 μm to about 100 μm.

17. The method of claim 1, wherein generating liquid droplets is performed using a microfluidic process.

18-31. (canceled)

32. A composition prepared by the method of claim 1.

33. A composition comprising a polymer and hybrid metal oxide particles comprising:
a continuous matrix of a first metal oxide having embedded therein an array of metal oxide particles, the metal oxide particles comprising a second metal oxide, wherein the hybrid metal oxide particles are substantially non-porous, wherein the hybrid metal oxide particles are present in an amount of 0.1 wt % to about 40 wt %.

34-48. (canceled)

49. A method of preparing a composition comprising a polymer and hybrid metal oxide particles, wherein the hybrid metal oxide particles are prepared by a method comprising:
generating liquid droplets from a particle dispersion comprising a binder and metal oxide particles; and
drying the liquid droplets to form hybrid metal oxide particles comprising a matrix of the binder and an array of the metal oxide particles embedded in the matrix, wherein the hybrid metal oxide particles are present in an amount of 0.1 wt % to about 40 wt %.

50-60. (canceled)
